(19) United States
(12) Patent Application Publication
(10) Pub. No.: US 2026/0349671 A1
(43) Pub. Date: Nov. 5, 2026

(54) DIRECTED ARTIFICIAL INTELLIGENCE AND AUTOMATED CODE MAINTENANCE SYSTEM

(71) Applicant: CodeLogic, Inc., San Francisco, CA (US)

(72) Inventors: Edwin Gnichtel, Madison, NJ (US); Brandon Tylke, Dover, OH (US)

(21) Appl. No.: 19/667,443

(22) Filed: May 4, 2026

Related U.S. Application Data
(60) Provisional application No. 63/800,314, filed on May 5, 2025.

(51) Int. Cl. G06F 8/33; G06F 8/75

(52) U.S. Cl. CPC G06F 8/33; G06F 8/75

(57) ABSTRACT

Embodiments of the present disclosure provide for providing automated code maintenance using artificial intelligence (AI). Such embodiments may include determining multigraph differential data indicative of a difference between a first state and a second state of a knowledge graph for a plurality of Information Technology (IT) assets, inputting the multigraph differential data to a first AI model to generate a structured differential data set for the multigraph differential data, inputting the structured differential data set to a second AI model to generate a plurality of remediation instruction data structures for the plurality of IT assets, inputting the plurality of remediation instruction data structures to a third AI model to generate modified IT asset data for the plurality of IT assets, and causing execution of a remediation action for the plurality of IT assets based on the modified IT asset data.

### CROSS REFERENCE TO RELATED APPLICATIONS

This application claims priority to U.S. Prov. Pat. App. No. 63/800,314 filed May 5, 2025, the contents of which are incorporated herein in its entirety by reference.

### TECHNOLOGICAL FIELD

Embodiments of the present disclosure generally relate to artificial intelligence modeling, and more particularly to automated code maintenance using artificial intelligence.

### BACKGROUND

Computer-executable instructions for computing systems have grown increasingly complex, often comprising thousands of data classes, database tables, and complex internal and external dependencies with maintenance and execution challenges to maintain proper functionality. Further, current techniques for managing computing systems lack comprehensive understanding of architecture, dependency relationships, and cascading impacts of changes to computer-executable instructions across large-scale application systems. Through applied effort, ingenuity, and innovation, Applicant has solved many of these identified problems by developing the embodiments in the present disclosure, which are described in detail below.

### BRIEF SUMMARY

Various embodiments described herein relate to apparatus(es), method(s), system(s), and/or computer program product(s) for providing directed artificial intelligence and automated code maintenance.

In an embodiment, an apparatus comprises one or more processors and one or more storage devices storing instructions that are operable, when executed by the one or more processors, to cause the one or more processors to determine multigraph differential data indicative of a difference between a first state and a second state of a knowledge graph for a plurality of Information Technology (IT) assets. The instructions are additionally or alternatively operable, when executed by the one or more processors, to cause the one or more processors to input the multigraph differential data to a first artificial intelligence (AI) model to generate a structured differential data set for the multigraph differential data that is formatted according to input formatting criteria for a second AI model. The instructions are additionally or alternatively operable, when executed by the one or more processors, to cause the one or more processors to input the structured differential data set to the second AI model to generate a plurality of remediation instruction data structures for the plurality of IT assets. The instructions are additionally or alternatively operable, when executed by the one or more processors, to cause the one or more processors to input the plurality of remediation instruction data structures to a third AI model to generate modified IT asset data for the plurality of IT assets. The instructions are additionally or alternatively operable, when executed by the one or more processors, to cause the one or more processors to cause execution of a remediation action for the plurality of IT assets based on the modified IT asset data.

In another embodiment, a computer-implemented method provides for determining multigraph differential data indicative of a difference between a first state and a second state of a knowledge graph for a plurality of IT assets. The computer-implemented method additionally or alternatively provides for inputting the multigraph differential data to a first AI model to generate a structured differential data set for the multigraph differential data that is formatted according to input formatting criteria for a second AI model. The computer-implemented method additionally or alternatively provides for inputting the structured differential data set to the second AI model to generate a plurality of remediation instruction data structures for the plurality of IT assets. The computer-implemented method additionally or alternatively provides for inputting the plurality of remediation instruction data structures to a third AI model to generate modified IT asset data for the plurality of IT assets. The computer-implemented method additionally or alternatively provides for causing execution of a remediation action for the plurality of IT assets based on the modified IT asset data.

In yet another embodiment, one or more non-transitory computer-readable storage media store instructions that, when executed by one or more processors, cause the one or more processors to determine multigraph differential data indicative of a difference between a first state and a second state of a knowledge graph for a plurality of IT assets. The instructions, when executed by the one or more processors, additionally or alternatively cause the one or more processors to input the multigraph differential data to a first AI model to generate a structured differential data set for the multigraph differential data that is formatted according to input formatting criteria for a second AI model. The instructions, when executed by the one or more processors, additionally or alternatively cause the one or more processors to input the structured differential data set to the second AI model to generate a plurality of remediation instruction data structures for the plurality of IT assets. The instructions, when executed by the one or more processors, additionally or alternatively cause the one or more processors to input the plurality of remediation instruction data structures to a third AI model to generate modified IT asset data for the plurality of IT assets. The instructions, when executed by the one or more processors, additionally or alternatively cause the one or more processors to cause execution of a remediation action for the plurality of IT assets based on the modified IT asset data.

Various other embodiments are also described in the following detailed description and in the attached claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that can be specially configured within which at least one example embodiment of the present disclosure may operate;

FIG. 2 illustrates a block diagram of an example apparatus that can be specially configured in accordance with at least one example embodiment of the present disclosure;

FIG. 3 illustrates an example data flow system as part of a process for providing automated code maintenance using artificial intelligence in accordance with at least one example embodiment of the present disclosure;

FIG. 4 illustrates an example directed artificial intelligence system for automated code maintenance in accordance with at least one example embodiment of the present disclosure;

FIG. 5 illustrates an example system for managing knowledge graph data across multiple logical partitions in accordance with at least one example embodiment of the present disclosure;

FIG. 6 illustrates an example process that includes an automated artificial intelligence pipeline for code maintenance in accordance with at least one example embodiment of the present disclosure;

FIG. 7 illustrates an example representation showing inter-dependency of a plurality of IT assets utilized in a computing system in accordance with at least one example embodiment of the present disclosure; and

FIG. 8 illustrates a process depicting example operations for providing automated code maintenance using artificial intelligence in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure can take many different forms and should not be construed as limited to the exemplary embodiments set forth herein, rather, these embodiments are provided so that this disclosure will satisfy applicable legal requirements. Like numbers refer to like elements throughout.

### OVERVIEW

Internet technology (IT) assets (e.g., codebases or other IT assets) for computing systems have grown increasingly complex, often comprising thousands of data classes, database tables, and complex internal and external dependencies with maintenance and execution challenges to maintain proper functionality. Further, current techniques for managing IT assets for computing systems lack comprehensive understanding of architecture, dependency relationships, and cascading impacts of changes to computer-executable instructions across large-scale application systems. For example, an application system may include 5,000 data classes, 300 data tables, and 4,700 structured query language (SQL) functions, resulting in thousands of dependencies between IT assets for the application system. Such complexity may result in degraded functionality for the IT assets and increased computing resources to maintain the application system.

Further, traditional IT asset development lifecycle approaches for a computing system may fail to adequately address this complexity. For instance, traditional approaches for maintaining IT assets for a computing system may involve manual analysis of dependencies between IT assets, manual identification of impacts from library or framework changes, and manual remediation of affected IT assets. Such manual approaches may consume significant time and computing resources, with typical library or framework changes requiring days to weeks for completion, and larger framework upgrades requiring weeks to months. Additionally, traditional approaches may involve substantial hidden and obvious resource consumption including ticketing, sprint preparation, research, development and implementation, synchronization calls, testing, and iterative processes that repeat as impacts cascade through the system. Additionally, traditional artificial intelligence (AI) approaches to development of IT assets may be effective for generating new IT assets but may lack comprehensive understanding of existing IT asset architecture, dependency relationships, and the cascading impacts of changes to IT assets across large-scale application systems. Moreover, traditional approaches may lack mechanisms for continuous monitoring of dependency changes among IT assets and automated triggering of remediation workflows for IT assets, resulting in reactive rather than proactive maintenance of IT assets for a computing system.

Embodiments of the present disclosure utilize directed artificial intelligence and automated AI asset maintenance (e.g., automated code maintenance) to address these and/or other technical challenges. For example, embodiments may utilize a knowledge graph that comprehensively maps IT asset dependencies through binary artifact decomposition, runtime inspection, and database schema scanning. The knowledge graph may capture structural information regarding code-generated artifacts, source code, data architecture, data schema, and other elements related to application system dependencies. Embodiments may further utilize multigraph differential analysis to identify differences between current and prior states of the knowledge graph, enabling detection of dependency changes to initiate the automated AI asset maintenance.

In this regard, embodiments of the present disclosure may utilize a multi-stage AI pipeline for the automated AI asset maintenance. For example, multigraph differential data may be input to a first AI model to generate a structured differential data set formatted according to input formatting criteria for a second AI model. The structured differential data set may then be input to the second AI model to generate remediation instruction data structures that contain instructions for addressing identified differences. The remediation instruction data structures may subsequently be input to a third AI model to generate modified IT asset data representing updated IT asset data or configuration changes. Embodiments may further cause execution of remediation actions based on the modified IT asset data, such as submission of pull requests or merge requests to repositories for IT assets.

In some embodiments, a model context protocol (MCP) server may be utilized to provide data structure and/or context to AI models via MCP prompts. For instance, the MCP server may interact with analysis and plug-in engine APIs to access knowledge graph data, differential analysis results, and/or impact information. Embodiments may further utilize extensible workflows of embedded or chained prompts, where results from one prompt serve as input to subsequent prompts. Such MCP-based approaches may enable AI models to perform impact assessments, dependency evaluations, generation of recommendations, and IT asset generation with comprehensive understanding of IT asset architecture and dependencies.

Embodiments of the present disclosure may further utilize automated maintenance loops that may operate without user input. For example, mechanisms may interact via APIs to accept notifications from dependency monitoring systems, triggering automated remediation workflows in response to detected dependency changes. Embodiments may utilize annotations or attributes added to IT assets to inform the system of important conditions to evaluate for change notifications. The automated maintenance loop may be iterative in nature, functioning as a continuous event-driven maintenance process where updates to IT assets trigger knowledge graph updates, which generate notifications that lead to differential analysis, followed by AI-directed generation of IT asset data that produces new updated IT asset data, perpetuating the cycle.

Some embodiments provide technical improvements by enabling automated remediation of maintenance challenges and/or complexity of IT assets without manual intervention. For example, embodiments may reduce or eliminate the time and resources traditionally required for library and framework upgrades by automating impact analysis, ticket generation, and modification of IT asset data via the multi-stage AI pipeline. Embodiments may further provide technical improvements by enabling comprehensive dependency analysis that accounts for binary artifacts, runtime behavior, and database relationships, resulting in more accurate impact assessments and more effective modifications to IT asset data. Additionally, embodiments may provide technical improvements by enabling continuous monitoring and automated remediation of dependency changes, shifting maintenance of IT assets from a reactive to a proactive approach. Such technical improvements may reduce utilization of computing resources, minimize security risks associated with outdated dependencies, and improve performance of IT assets over time.

Various embodiments of the present disclosure also improve a computing system by providing for both improvements in efficiency as well as reductions in error, inconsistencies, and/or other problems associated with IT assets for the computing system. For instance, by utilizing one or more embodiments related to artificial intelligence and automated AI asset maintenance as disclosed herein, a number of computing resource and/or a number of errors for managing or updating IT assets for a computing system may be reduced as compared to traditional IT asset maintenance approaches.

### EXAMPLE TERMINOLOGY

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, sensor devices, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

In some embodiments, the terms “client device,” “computing device,” “user device,” and the like may be used interchangeably to refer to computer hardware configured (either physically or by the execution of software) to access one or more applications, services, or repositories made available by a server. Among various other functions, these computing devices are configured to directly or indirectly transmit and receive data via a network. The server is often (but not always) on another computer system, in which case the client device accesses the service by way of a communication network.

Example client devices include, without limitation, smartphones (e.g., Apple iPhone, Samsung Galaxy, Google Pixel), tablet computers (e.g., Apple iPad, Microsoft Surface, etc.), laptop computers (e.g., Apple MacBook, Dell XPS, Lenovo ThinkPad, etc.), wearable devices (e.g., smartwatches such as Apple Watch and Samsung Galaxy Watch, eyewear such as Google Glass and Meta Ray-Ban, helmets, hats, other wearable devices, clothing, earpieces with wireless connectivity such as Apple AirPods and Samsung Galaxy Buds, and the like), personal computers, desktop computers (e.g., Apple iMac, Dell OptiPlex, HP Pavilion), enterprise computers, workstations, and any other computing devices known to one skilled in the art in light of the present disclosure. Each client device may be associated with one or more user profiles and may implement authentication mechanisms to verify user identity

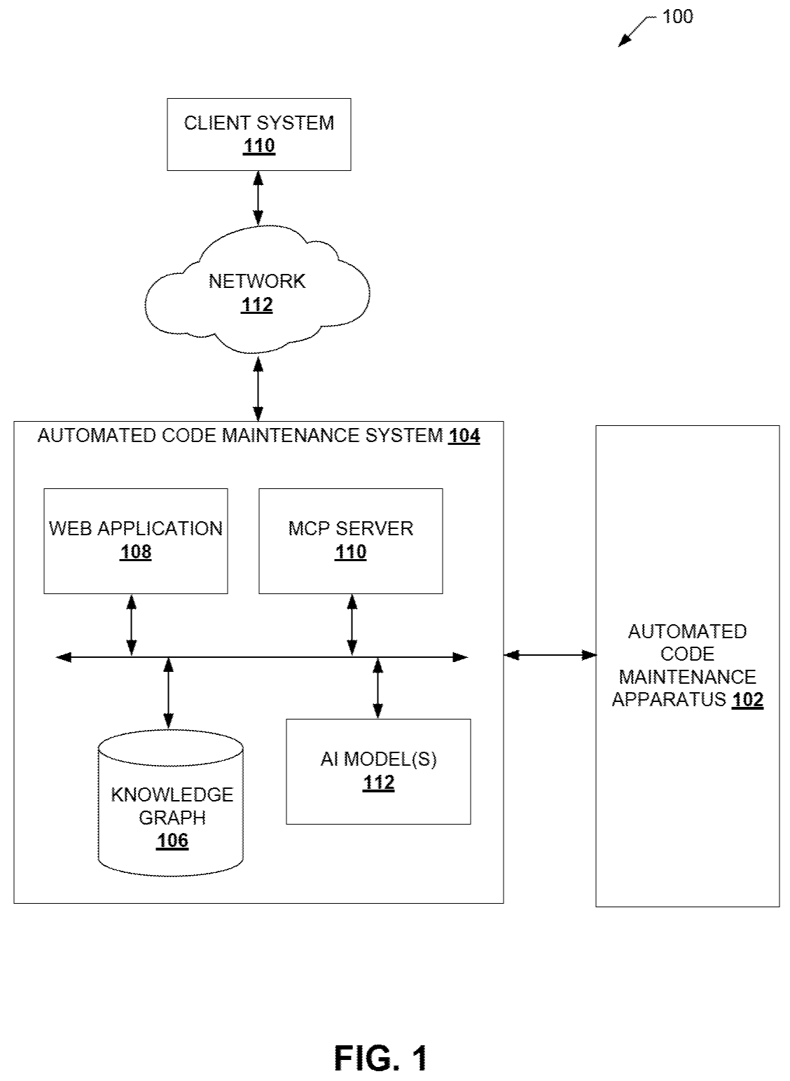

The term “server computing device” refers to a combination of computer hardware and/or software that is configured to provide a component to a client device. An example of a server computing device is the automated code maintenance system of FIG. 1. Another example of a server computing device is, in certain embodiments, the automated code maintenance apparatus 102 of FIG. 1. In some embodiments, a server computing device communicates with one or more client computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “AI model(s)” “machine learning module,” “machine learning model,” “ML model(s),” “artificial intelligence model(s),” or “AI model(s)” refer to computational systems that implement machine learning or deep learning algorithms. The term “artificial intelligence” or “AI” refers broadly to computer systems designed to perform tasks that typically require human intelligence, including but not limited to reasoning, learning, problem-solving, perception, and natural language understanding. The term “machine learning” refers to a subset of artificial intelligence encompassing methods and algorithms that enable computer systems to learn patterns from data and make predictions or decisions without being explicitly programmed with rules for each specific scenario. Machine learning models are computer-implemented algorithms that may learn from data stored in databases or datastores, with or without relying on rules-based programming. These models enable reliable, repeatable decisions and results and facilitate the uncovering of hidden insights through machine-based learning from historical relationships and trends in the data. Machine learning models may be accessed by applications and services via APIs and may be deployed within service-oriented platforms. In some embodiments, a machine learning model is a neural network model. In some embodiments, a machine learning model such as the task duration prediction model is a generative model (e.g., a generative AI model). In some embodiments, a machine learning model is a large language model. In some embodiments, an AI system that processes inputs to generate outputs through learned patterns and algorithms. An AI model may include machine learning models, neural networks, large language models, and other computational systems that perform automated analysis and decision-making.

Machine learning encompasses two primary learning paradigms: supervised learning and unsupervised learning. In supervised learning, a model is trained on a labeled dataset where each input example is paired with a corresponding target output or label. The model learns to map inputs to outputs by minimizing the difference between its predictions and the known labels. Examples of supervised learning tasks include classification and regression. Common supervised learning algorithms include linear regression, logistic regression, support vector machines (SVMs), decision trees, random forests, gradient boosting machines (e.g., XGBoost, LightGBM, CatBoost), k-nearest neighbors (KNN), and neural networks. In unsupervised learning, a model is trained on unlabeled data and must discover patterns, structures, or relationships within the data without explicit guidance. Examples of unsupervised learning tasks include clustering (e.g., grouping similar data points together using algorithms such as k-means, hierarchical clustering, DBSCAN, or Gaussian mixture models), dimensionality reduction (e.g., reducing the number of features while preserving important information using techniques such as principal component analysis (PCA), t-SNE, or UMAP), and anomaly detection (e.g., identifying unusual patterns or outliers in data). Semi-supervised learning combines elements of both paradigms, using a small amount of labeled data alongside a larger amount of unlabeled data to improve model performance.

A machine learning model is initially fit or trained on a training dataset comprising a set of examples used to fit or adjust the parameters of the model. During training, the model processes input data, generates predictions or outputs, and compares these outputs against target values (in supervised learning) or optimization objectives (in unsupervised learning). Based on the result of this comparison and the specific learning algorithm being used, the parameters of the model are adjusted through optimization techniques such as gradient descent, stochastic gradient descent (SGD), Adam, RMSprop, or other optimization algorithms. Training data may be stored in databases or datastores and accessed via APIs. The training process typically involves iterating over the training data multiple times (epochs) until the model converges to a satisfactory level of performance. Model performance is evaluated using metrics appropriate to the task, such as accuracy, precision, recall, F1 score, area under the ROC curve (AUC-ROC), mean squared error (MSE), mean absolute error (MAE), or other evaluation metrics. The machine learning models as described herein may make use of multiple ML engines (e.g., for analysis, transformation, inference, and other needs). The system may train different ML models for different needs and different ML-based engines, generate new models based on gathered training data, and evaluate their performance against existing models

The term “feature engineering” refers to the process of using domain knowledge to select, transform, extract, or create input variables (features) from raw data to improve the performance of machine learning models. Feature engineering techniques include feature selection (identifying the most relevant features for a given task), feature extraction (deriving new features from existing data, such as extracting statistical measures, frequency components, or textual features), feature transformation (applying mathematical transformations such as normalization, standardization, log transformation, or polynomial expansion), and feature encoding (converting categorical variables into numerical representations using techniques such as one-hot encoding, label encoding, or target encoding). Effective feature engineering may significantly impact model accuracy and generalization capability. Automated feature engineering tools and techniques, such as those provided by frameworks like Featuretools, AutoML systems (e.g., Google AutoML, H2O AutoML, Auto-sklearn), or feature stores (e.g., Feast, Tecton, Amazon SageMaker Feature Store), may assist in discovering and managing features at scale within service-oriented platforms.

Deep learning represents a subset of machine learning that utilizes artificial neural networks with multiple layers (deep neural networks) to learn hierarchical representations of data. Neural network architectures include feedforward neural networks, convolutional neural networks (CNNs) for image and spatial data processing (e.g., ResNet, VGG, EfficientNet, YOLO for object detection), recurrent neural networks (RNNs) and long short-term memory networks (LSTMs) for sequential data processing, and transformer architectures for natural language processing and other sequence-to-sequence tasks. Deep learning frameworks such as TensorFlow, PyTorch, JAX, Keras, and MXNet provide tools for building, training, and deploying neural network models. Deep learning models may be trained on specialized hardware including graphics processing units (GPUs) from manufacturers such as NVIDIA (e.g., A100, H100, RTX series) and AMD, tensor processing units (TPUs) from Google, and other AI accelerators. Model training may be distributed across multiple computing nodes within cloud computing environments provided by Amazon Web Services, Microsoft Azure, Google Cloud Platform, or other cloud providers.

The term “generative AI” or “generative artificial intelligence” refers to a category of artificial intelligence systems designed to generate new content, including text, images, audio, video, code, or other data types. Generative AI models learn patterns and structures from training data and use this learned knowledge to create novel outputs that resemble the training data distribution. Examples of generative AI architectures include generative adversarial networks (GANs), which consist of a generator network that creates synthetic data and a discriminator network that distinguishes between real and generated data (e.g., StyleGAN, BigGAN, CycleGAN); variational autoencoders (VAEs), which learn compressed latent representations of data and can generate new samples by sampling from the latent space; diffusion models, which learn to reverse a gradual noising process to generate high-quality samples (e.g., Stable Diffusion, DALL-E, Midjourney, Imagen); and autoregressive models, which generate sequences by predicting one element at a time based on previously generated elements. Generative AI applications include text generation, image synthesis, music composition, audio generation, video generation, code generation (e.g., GitHub Copilot, Amazon CodeWhisperer, Tabnine), and creative content production. Generative AI models may be deployed within service-oriented platforms and accessed via APIs.

Large language models (LLMs) represent a specialized category of generative AI models designed to understand, generate, and manipulate human language. These models, such as GPT (Generative Pre-trained Transformer) series from OpenAI (e.g., GPT-3.5, GPT-4, GPT-4o), Claude from Anthropic, LLaMA and Llama 2 from Meta, PaLM and Gemini from Google, BERT (Bidirectional Encoder Representations from Transformers), RoBERTa, T5, Falcon, Mistral, and Cohere models, are typically built using transformer architectures with parameters ranging from millions to hundreds of billions. The training process for LLMs involves multiple phases: pre-training on vast corpora of text data (often hundreds of gigabytes to terabytes of text from sources such as web pages, books, articles, and code repositories) to learn general language patterns, syntax, semantics, and world knowledge; followed by fine-tuning on domain-specific datasets to specialize the model for particular applications. For IT asset development support applications and other specialized use cases, LLMs may undergo additional reinforcement learning from human feedback (RLHF) or reinforcement learning from AI feedback (RLAIF), where human evaluators or AI systems rate model outputs to improve response quality, helpfulness, harmlessness, and alignment with organizational policies. Constitutional AI (CAI) represents another alignment technique where models are trained to follow specified principles or guidelines. LLM inference may be performed via APIs provided by model providers or through self-hosted deployments within enterprise environments.

LLMs and other machine learning models can be further enhanced through techniques such as retrieval-augmented generation (RAG), which allows models to access and incorporate external knowledge bases, databases, or datastores during inference, making them particularly effective for technical support scenarios, question answering systems, and other applications where accurate, up-to-date information is critical. RAG systems typically combine a retrieval component (which searches for relevant documents or passages from a knowledge base using vector similarity search or other retrieval methods) with a generation component (which synthesizes retrieved information into coherent responses). Other enhancement techniques include prompt engineering (crafting effective input prompts to elicit desired model behaviors), few-shot learning (providing examples within the prompt to guide model responses), chain-of-thought prompting (encouraging step-by-step reasoning), and model fine-tuning using techniques such as Low-Rank Adaptation (LoRA), QLoRA, or full fine-tuning on domain-specific datasets. Machine learning models may implement various algorithms beyond neural networks, including ensemble methods (e.g., bagging, boosting, stacking), Bayesian methods, genetic algorithms, and reinforcement learning algorithms (e.g., Q-learning, policy gradient methods, actor-critic methods).

The ML models may undergo a training or learning phase before they are released into a production or runtime phase, or may begin operation with pre-trained models from existing systems or model repositories (e.g., Hugging Face Model Hub, TensorFlow Hub, PyTorch Hub, NVIDIA NGC). During a training or learning phase, the ML models may be tuned to focus on specific variables, to reduce error margins, to prevent overfitting through regularization techniques (e.g., L1/L2 regularization, dropout, early stopping), or to otherwise optimize their performance through hyperparameter tuning using techniques such as grid search, random search, Bayesian optimization, or automated hyperparameter optimization tools (e.g., Optuna, Ray Tune, Hyperopt). The ML models may initially receive input from a wide variety of data stored in databases or datastores, such as the gathered data described herein. Model versioning and experiment tracking may be managed using MLOps tools such as MLflow, Weights & Biases, Neptune, or Kubeflow. The ML models herein may undergo subsequent training phases for retraining, fine-tuning, or continuous learning to adapt to new data distributions or changing requirements. Model deployment may occur within containerized environments using technologies such as Docker and Kubernetes, with model serving frameworks such as TensorFlow Serving, TorchServe, Triton Inference Server, or Seldon Core enabling scalable inference within service-oriented platforms.

The term “multigraph differential data” refers to data that indicates differences between states of a knowledge graph representing IT assets and their dependencies. Multigraph differential data captures changes in dependencies, relationships, and structural information for IT assets by comparing a current state of the knowledge graph with a prior state. In some examples, the multigraph differential data may comprise hundreds to thousands of lines of differential data representing changes across the IT assets monitored by the system. In some embodiments, the multigraph differential data includes graph differentials that are utilized for computing impact, including particular edges that represent dependencies that have been disrupted by changes to IT assets. In some embodiments, multigraph differential data is determined by evaluating knowledge graph states to identify differences between materialized views associated with logical graph partitions of the knowledge graph. The multigraph differential data may be determined in response to an API notification that indicates the difference between the first state and the second state of the knowledge graph. Once determined, the multigraph differential data is input to an AI model to generate a structured differential data set that is formatted according to input formatting criteria for a second AI model. The multigraph differential data serves as the foundation for the multi-stage AI pipeline that transforms differential graph data into actionable code modifications for IT asset remediation.

The term “knowledge graph” refers to a data structure that comprehensively maps IT asset dependencies and relationships within an IT asset system. A knowledge graph captures structural information regarding code-generated artifacts, source code, data architecture, data schema, and/or other elements related to application system dependencies. The knowledge graph is built through binary artifact decomposition, runtime inspection, and database schema scanning to provide a comprehensive representation of IT asset dependencies. The knowledge graph may be implemented as a graph database that stores nodes representing IT assets and edges representing dependencies and relationships between those IT assets. In some embodiments, the knowledge graph includes scanspace logical graph partitions which are used to store inbound data from agents. The agents may be configured to gather structural information about sets of code-generated artifacts, source code, data architecture, data schema, and/or other elements related to application system dependencies and architecture. The knowledge graph supports multiple logical graph partitions referred to as materialized views, which can generate complete or subset views of data composited from scanspace partitions. The knowledge graph may also be continuously updated based on modified IT asset data generated through the automated code maintenance process, enabling continuous event-driven maintenance where changes detected in the knowledge graph trigger automated remediation workflows.

The term “IT asset” refers to an IT resource that is part of an IT asset system and is tracked within the knowledge graph. IT assets include codebases, data classes, database tables, methods, structured query language functions, libraries, frameworks, and/or other computer-executable components that form part of an application system. IT assets may have complex dependencies between them, with an application system potentially including thousands of data classes, hundreds of data tables, and thousands of structured query language functions, resulting in thousands of dependencies between IT assets. In some embodiments, IT assets are analyzed by agents that perform binary artifact decomposition, runtime inspection, and/or database schema scanning to comprehensively map dependencies. The structural information gathered about IT assets is stored in scanspace logical graph partitions within the knowledge graph. IT assets may be associated with annotations or attributes that inform the system of important conditions to evaluate for change notifications. When changes are detected in IT assets or their dependencies, the automated code maintenance apparatus determines multigraph differential data, processes the differential data through multiple AI models, and generates modified IT asset data to remediate the affected IT assets.

The term “structured differential data set” refers to a formatted representation of multigraph differential data that is organized according to input formatting criteria for processing by a subsequent AI model. A structured differential data set represents the output of the first stage of AI processing in the multi-stage AI pipeline. The structured differential data set may organize and format the differential information from the multigraph differential data in a manner that enables effective processing by subsequent AI models. In some embodiments, the structured differential data set is generated by a first AI model that performs complex analysis of graph differentials, including analysis of graph differential data to transform the multigraph differential data into a format suitable for subsequent processing. In some embodiments, the structured differential data set includes categorized changes, prioritized impacts, and/or structured representations of the differences identified in the knowledge graph. The formatting of the structured differential data set according to input formatting criteria for a second AI model enables efficient and accurate generation of remediation instructions in the subsequent processing stage. The structured differential data set is input to the second AI model to generate a plurality of remediation instruction data structures for the plurality of IT assets.

The term “input formatting criteria” refers to rules that define how data should be structured and organized for processing by an AI model. Input formatting criteria establish the format, structure, and/or organization rules that enable an AI model to effectively process input data and generate appropriate outputs. The input formatting criteria ensure that data passed between stages of the multi-stage AI pipeline is compatible with the receiving AI model. Input formatting criteria may be used by the first AI model when generating the structured differential data set to ensure the output is formatted appropriately for the second AI model. The input formatting criteria may specify data organization requirements, field structures, categorization schemes, and/or other formatting parameters that enable the second AI model to accurately interpret and process the structured differential data set. By adhering to input formatting criteria, the multi-stage AI pipeline maintains data compatibility across processing stages, enabling each AI model to receive output from the preceding model in a format that supports effective processing.

The term “remediation instruction data structure” refers to a data structure that contains instructions for addressing differences identified in the knowledge graph. Remediation instruction data structures may comprise tickets that contain instructions for addressing the differences identified in the knowledge graph. For example, the remediation instruction data structures may include actionable tickets with associated prompts that effectively serve as prompt generation for subsequent AI processing. In some embodiments, remediation instruction data structures are generated by a second AI model based on the structured differential data set. The second AI model processes the structured differential data set to generate a plurality of remediation instruction data structures for the plurality of IT assets. In some embodiments, impact analysis may be performed on the knowledge graph to determine impact information associated with the multigraph differential data prior to generating the plurality of remediation instruction data structures. The impact analysis may include cyclomatic complexity scoring, confidence scores, and/or security exposure analysis. Additionally, the remediation instruction data structures may be subsequently input to a third AI model to generate modified IT asset data for the plurality of IT assets.

The term “modified IT asset data” refers to data representing updated code or configuration changes for IT assets that address differences identified in the knowledge graph. Modified IT asset data represents the output of the third stage of AI processing in the multi-stage AI pipeline. The modified IT asset data comprises updated code, configuration changes, or other modifications to the IT assets that address the differences identified in the knowledge graph. In some embodiments, modified IT asset data is generated by a third AI model based on the remediation instruction data structures. In some embodiments, the third AI model directs a coding AI to write code based on the remediation instruction data structures, with continuous checking and rechecking of the generated code. In some embodiments, the modified IT asset data includes generated code that has been checked and rechecked by the third AI model to ensure accuracy and compatibility with the existing IT asset architecture. The modified IT asset data may include modifications to multiple IT assets across the plurality of IT assets monitored by the system. The modified IT asset data may be used to cause execution of a remediation action for the plurality of IT assets.

The term “remediation action” refers to an operation that deploys modifications to IT assets based on modified IT asset data. A remediation action represents the deployment of the modifications generated by the AI models to the IT assets. In some embodiments, the remediation action comprises submission of pull requests or merge requests to repositories for IT assets. In some embodiments, remediation actions are executed based on the modified IT asset data. In some embodiments, the remediation action updates the knowledge graph, completing an iterative workflow that enables continuous event-driven maintenance. Following execution of a remediation action, the automated code maintenance apparatus may update the knowledge graph based on the modified IT asset data, determine updated multigraph differential data indicative of a difference between an updated current state and a current state of the knowledge graph, and input the updated multigraph differential data to the first AI model to continue the automated maintenance loop. This iterative process enables the system to reevaluate based on change request functionality and loop the process in the event of problems detected in generated code.

The term “API notification” refers to an API call or API message that indicates a difference between a first state and a second state of the knowledge graph. An API notification may serve as a trigger for the automated remediation workflow, initiating the process of analyzing differential data and generating remediation actions. The API notification may be received from automated agents or other dependency monitoring tools that detect changes in libraries, frameworks, or other dependencies utilized by the IT assets. In some embodiments, API notifications are generated by a dependency monitoring system that monitors the knowledge graph based on an IT asset vulnerability rules set. The dependency monitoring system evaluates the knowledge graph for changes and generates API notifications when changes are detected. API notifications may also be generated based on annotations or attributes added to IT assets that inform the system of important conditions to evaluate for change notifications. When an API notification is received, the automated code maintenance apparatus determines multigraph differential data indicative of a difference between a first state and a second state of the knowledge graph for a plurality of IT assets, initiating the multi-stage AI processing pipeline. In some embodiments, the first state may be a current state of the IT assets and the second state may be a proposed state of the IT assets. In other embodiments, the first state may be a current state of the IT assets and the second state may be a prior state of the IT assets.

The term “dependency monitoring system” refers to a system that monitors the knowledge graph for changes in IT asset dependencies. A dependency monitoring system represents a continuous monitoring process that evaluates the knowledge graph for changes. The dependency monitoring system may operate as part of an automated maintenance loop that functions without user input, enabling continuous event-driven maintenance of IT assets. In some embodiments, the dependency monitoring system monitors the knowledge graph based on an IT asset vulnerability rules set that defines conditions under which notifications should be generated. The dependency monitoring system may utilize mechanisms that interact via APIs to accept notifications from dependency monitoring systems. Additionally, the dependency monitoring system may evaluate annotations or attributes added to IT assets that inform the system of important conditions to evaluate for change notifications. When changes are detected in the knowledge graph, the dependency monitoring system generates an API notification that triggers the automated remediation workflow.

The term “IT asset vulnerability rules set” refers to a set of rules that defines conditions under which notifications should be generated for IT asset changes. An IT asset vulnerability rules set establishes the criteria for determining when changes in the knowledge graph warrant triggering the automated remediation workflow. The IT asset vulnerability rules set may include rules related to security vulnerabilities, dependency version changes, compatibility issues, and/or other conditions that affect IT asset functionality. In some embodiments, the IT asset vulnerability rules set is used by the dependency monitoring system when monitoring the knowledge graph. The dependency monitoring system evaluates the knowledge graph against the IT asset vulnerability rules set to determine whether detected changes meet the criteria for generating an API notification. By defining specific conditions in the IT asset vulnerability rules set, the system can focus automated remediation efforts on changes that are most likely to impact IT asset functionality, security, or performance.

The term “unresolved IT asset reference” refers to an element that connects to a graph edge in the knowledge graph and is known to exist but cannot be fully described and populated without further information. Unresolved IT asset references, also referred to as search nodes, represent elements that are known to exist within the IT asset dependency structure but require additional information from other systems to be fully characterized. These are defined graph types that specifically represent elements that connect to a graph edge and are known to exist but cannot be fully described and populated without further information, potentially from some other system. In some embodiments, unresolved IT asset references are computed by an analysis and plug-in engine as graph placeholder references. The unresolved IT asset references are associated with graph nodes of the knowledge graph and are included in the multigraph differential data. The materialized views may be used to create differential comparisons between different sets of scanspace data, with reference to search nodes. Unresolved IT asset references enable the system to track dependencies that extend beyond the boundaries of the currently analyzed IT assets, supporting comprehensive impact analysis across complex IT asset systems.

The term “materialized view” refers to a logical partition that generates complete or subset views of data composited from scanspace partitions. For instance, materialized views may be logical partitions within the knowledge graph that can generate complete or subset views of data composited from scanspace partitions. Additionally, materialized views may be used to create differential comparisons between different sets of scanspace data, with reference to search nodes. In some embodiments, materialized views are generated by the analysis and plug-in engine and are contained within workspaces. In some embodiments, a first materialized view represents a current state of the knowledge graph for a set of IT assets, while a second materialized view represents a prior state of the knowledge graph for the same set of IT assets. This configuration enables the system to determine multigraph differential data indicative of a difference between the first state and the second state of the knowledge graph. The materialized views may also include audit components and/or additional processing elements that facilitate tracking of changes and generation of differential data.

The term “logical graph partition” refers to a subdivision of the knowledge graph that organizes data into distinct logical sections. Logical graph partitions enable the knowledge graph to be organized into separate sections that can be independently managed, accessed, and analyzed. Scanspace logical graph partitions are used to store inbound data from agents, while materialized views represent logical partitions that generate views of data composited from scanspace partitions. In some embodiments, logical graph partitions support the organization of IT asset dependency information across multiple workspaces. The first state and the second state of the knowledge graph may be represented as a respective materialized view associated with a logical graph partition of the knowledge graph. Logical graph partitions enable differential comparisons between different sets of scanspace data and support role-based access control security levels that control access to the scanspace partitions and materialized views within respective workspaces.

The term “MCP server” refers to a model context protocol server that provides model context data to AI models via model context protocol prompts. An MCP server facilitates communication between the automated code maintenance system and the AI models by providing data structure and context via model context protocol prompts. The MCP server supports extensible workflows of embedded or chained prompts, where results from one prompt serve as input to subsequent prompts. In some embodiments, the MCP server interacts with analysis and plug-in engine application programming interfaces to access knowledge graph data, differential analysis results, and impact information. The MCP server is communicatively coupled to the integrated development environment and AI plugins, facilitating communication between the development environment and the AI models. At least one of the first AI model, the second AI model, or the third AI model may be communicatively coupled to the MCP server that provides model context data via one or more model context protocol prompts.

The term “MCP prompt” refers to a model context protocol prompt that provides data structure and/or context to one or more AI models. Model context protocol prompts enable the MCP server to communicate with AI models by providing structured context information that guides the AI processing. The model context protocol prompts support extensible workflows of embedded or chained prompts, where results from one prompt serve as input to subsequent prompts. In some embodiments, model context protocol prompts are used throughout the multi-stage AI pipeline to provide context to each AI model. In some embodiments, the automated code maintenance apparatus inputs the multigraph differential data and the one or more model context protocol prompts to the first AI model to generate the structured differential data set. Similarly, the automated code maintenance apparatus may input the structured differential data set and the one or more model context protocol prompts to the second AI model to generate the plurality of remediation instruction data structures, and may input the plurality of remediation instruction data structures and the one or more model context protocol prompts to the third AI model to generate the modified IT asset data.

The term “model context data” refers to data that provides structure and context to AI models via model context protocol prompts. Model context data enables one or more AI models to perform operations with comprehensive understanding of IT asset architecture and dependencies. The model context data may include knowledge graph data, differential analysis results, impact information, and/or other contextual information that guides AI processing. In some embodiments, model context data is provided by the MCP server to the AI models via model context protocol prompts. The model context data also enables one or more AI models to perform impact assessments, dependency evaluations, generation of recommendations, and/or IT asset generation with comprehensive understanding of IT asset architecture and dependencies. By providing model context data through the MCP server, the system enables AI models to generate more accurate and contextually appropriate outputs throughout the multi-stage AI pipeline.

### EXAMPLE SYSTEMS

FIG. 1 illustrates a block diagram of a system that can be specially configured within which embodiments of the present disclosure may operate. Specifically, FIG. 1 illustrates an example system 100 for automated code maintenance using directed artificial intelligence. The example system 100 includes an automated code maintenance apparatus 102 and an automated code maintenance system 104. The automated code maintenance system 104 includes a knowledge graph 106, a web application 108, an MCP server 110, and AI model(s) 112. In one or more embodiments, the system 100 enables transmission of data between one or more subsystem(s) and/or device(s) of the system 100 to facilitate automated analysis, AI-directed remediation, and deployment of code modifications for maintaining IT asset systems.

The automated code maintenance apparatus 102 includes one or more computer(s) embodied in hardware, software, firmware, and/or a combination thereof. In some embodiments, the automated code maintenance apparatus 102 includes one or more application server(s), database server(s), enterprise computing terminal(s), and/or the like that are configured to perform the functionality described herein. In some embodiments, the automated code maintenance apparatus 102 embodies or includes a backend system (e.g., one or more enterprise server(s)) that are communicable over one or more network(s) (e.g., via the Internet). Additionally or alternatively, in some embodiments, the automated code maintenance apparatus 102 includes one or more virtual computer(s) embodied in a software environment maintained via particular hardware, for example where the automated code maintenance apparatus 102 is maintained as a virtual environment on hardware of a central terminal supporting multiple software application(s). In some embodiments, the automated code maintenance apparatus 102 includes one or more hardware device(s) within the same physically defined space, such as a data warehouse, company headquarters, and/or the like associated with a particular entity. Alternatively or additionally, in some embodiments, the automated code maintenance apparatus 102 includes one or more hardware and/or software device(s) located remotely from one another and that communicate in conjunction with one another to provide the described functionality, for example embodied by one or more cloud computing system(s).

In some embodiments, the automated code maintenance apparatus 102 includes a plurality of sub-services that each support a portion of the functionality performed by the automated code maintenance apparatus 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the automated code maintenance apparatus 102 may embody specially-configured software applications executed on shared hardware. In some embodiments, the automated code maintenance apparatus 102 is communicatively coupled to the automated code maintenance system 104 and interacts with the knowledge graph 106, the web application 108, the MCP server 110, and the AI model(s) 112 to facilitate the creation, validation, and/or storage of multigraph differential data, structured differential data sets, remediation instruction data structures, and modified IT asset data within the system 100.

The automated code maintenance apparatus 102 is configured to determine multigraph differential data indicative of a difference between a first state and a second state of a knowledge graph for a plurality of IT assets. In some embodiments, the knowledge graph 106 comprehensively maps IT asset dependencies through binary artifact decomposition, runtime inspection, and database schema scanning. The knowledge graph captures structural information regarding code-generated artifacts, source code, data architecture, data schema, and other elements related to application system dependencies. In some embodiments, the automated code maintenance apparatus 102 determines the multigraph differential data in response to an API notification that indicates the difference between the first state and the second state of the knowledge graph. In some such embodiments, the API notification is generated by a dependency monitoring system that monitors the knowledge graph based on an IT asset vulnerability rules set.

The automated code maintenance apparatus 102 is further configured to input the multigraph differential data to a first AI model to generate a structured differential data set for the multigraph differential data that is formatted according to input formatting criteria for a second AI model. In some embodiments, the first AI model performs complex analysis of graph differentials to generate the structured differential data set. The structured differential data set may comprise mass analysis of graph differential data formatted for subsequent processing by the second AI model. In some embodiments, the multigraph differential data comprises one or more unresolved IT asset references associated with a graph node of the knowledge graph. The unresolved IT asset references, also referred to as search nodes, represent elements that connect to a graph edge and are known to exist but cannot be fully described and populated without further information, potentially from some other system.

The automated code maintenance apparatus 102 is further configured to input the structured differential data set to the second AI model to generate a plurality of remediation instruction data structures for the plurality of IT assets. In some embodiments, the remediation instruction data structures comprise work tickets that contain instructions for addressing the differences identified in the knowledge graph. The remediation instruction data structures may include actionable tickets with associated prompts that effectively serve as prompt generation for subsequent AI processing. In some embodiments, the automated code maintenance apparatus 102 performs impact analysis on the knowledge graph to determine impact information associated with the multigraph differential data prior to generating the plurality of remediation instruction data structures. The impact analysis may include cyclomatic complexity scoring, confidence scores, and security exposure analysis.

The automated code maintenance apparatus 102 is further configured to input the plurality of remediation instruction data structures to a third AI model to generate modified IT asset data for the plurality of IT assets. In some embodiments, the third AI model directs a coding AI to write code based on the remediation instruction data structures, with continuous checking and rechecking of the generated code. The modified IT asset data represents updated code or configuration changes for the IT assets. In some embodiments, the third AI model performs continuous checks via MCP prompt workflows until complete, including impact assessments and dependency evaluations, generation of recommendations, and code generation.

The automated code maintenance apparatus 102 is further configured to cause execution of a remediation action for the plurality of IT assets based on the modified IT asset data. In some embodiments, the remediation action comprises submission of pull requests or merge requests to repositories for IT assets. In some embodiments, the automated code maintenance apparatus 102 updates the knowledge graph based on the modified IT asset data, determines updated multigraph differential data indicative of a difference between a third state (e.g., an updated current state) and the second state (e.g., the current state) of the knowledge graph, and inputs the updated multigraph differential data to the first AI model to generate a second structured differential data set for the updated multigraph differential data that is formatted according to the input formatting criteria for the second AI model. In some such embodiments, the automated code maintenance apparatus 102 inputs the second structured differential data set to the second AI model to generate a second plurality of remediation instruction data structures for the plurality of IT assets, inputs the second plurality of remediation instruction data structures to the third AI model to generate second modified IT asset data for the plurality of IT assets, and causes execution of a second remediation action for the plurality of IT assets based on the second modified IT asset data. This iterative workflow enables continuous event-driven maintenance where changes detected in the knowledge graph trigger the automated remediation workflow, and the resulting modifications are fed back into the knowledge graph for subsequent monitoring and analysis.

In some embodiments, the first state and the second state of the knowledge graph are represented as a respective materialized view associated with a logical graph partition of the knowledge graph. The materialized views are logical partitions that can generate complete or subset views of data composited from scanspace partitions. Additionally, the materialized views may be used to create differential comparisons between different sets of scanspace data, with reference to search nodes.

The knowledge graph 106 stores data and instructions utilized by the automated code maintenance apparatus 102 during operation. In some embodiments, the knowledge graph 106 is a knowledge graph for the plurality of IT assets. For example, the knowledge graph 106 may store configuration data, metadata, and structural information about code-generated artifacts, source code, data architecture, data schema, and/or other elements related to application system dependencies. In some embodiments, the knowledge graph 106 includes scanspace logical graph partitions which are used to store inbound data from agents. The agents use a combination of methods and mechanisms to gather structural information about sets of code-generated artifacts, source code, data architecture, data schema, and other elements related to application system dependencies and architecture.

The web application 108 provides a user interface for interacting with the system 100. In some embodiments, the web application 108 comprises a browser-based single-page application (SPA) with API access that enables users to access functionality of the automated code maintenance system 104. The web application 108 may facilitate user interaction with the system 100 through network communications. In some embodiments, the web application 108 is utilized to render electronic interface(s) that provide details associated with impact analysis, dependency evaluations, recommendations, and code generation. In some such embodiments, the web application 108 operates as a front-end or user-facing application for accessing functionality of the automated code maintenance apparatus 102.

The MCP server 110 provides model context data to the AI model(s) 112 via one or more MCP prompts. In some embodiments, at least one of the first AI model, the second AI model, or the third AI model is communicatively coupled to the MCP server 110 that provides model context data via one or more MCP prompts. The MCP server 110 may interact with analysis and plug-in engine APIs to access knowledge graph data, differential analysis results, and impact information. In some embodiments, the MCP server 110 provides data structure and context via MCP prompts and supports extensible workflows of embedded or chained prompts, where results from one prompt serve as input to subsequent prompts. In some embodiments, the automated code maintenance apparatus 102 inputs (i) the multigraph differential data and (ii) the one or more MCP prompts to the first AI model to generate the structured differential data set. In some embodiments, the automated code maintenance apparatus 102 inputs (i) the structured differential data set and (ii) the one or more MCP prompts to the second AI model to generate the plurality of remediation instruction data structures. In some embodiments, the automated code maintenance apparatus 102 inputs (i) the plurality of remediation instruction data structures and (ii) the one or more MCP prompts to the third AI model to generate the modified IT asset data.

The AI model(s) 112 perform various artificial intelligence operations for code maintenance tasks. In some embodiments, the AI model(s) 112 include a first AI model, a second AI model, and a third AI model that process data in stages, with each model receiving output from the preceding model to progressively transform differential graph data into actionable code modifications for IT asset remediation. The AI model(s) 112 may perform impact assessments, dependency evaluations, generation of recommendations, and IT asset generation with comprehensive understanding of IT asset architecture and dependencies. In some embodiments, the AI model(s) 112 are not reliant on a specific model and may support different models, integrated development environments (IDEs), and other configurations.

In some embodiments, the first AI model, the second AI model, and/or the third AI model correspond to the same AI model. In other embodiments, the first AI model, the second AI model, and/or the third AI model are distinct AI models. For example, two or more of the first AI model, the second AI model, and the third AI model may comprise a corresponding AI model architecture. In some embodiments, two or more of the first AI model, the second AI model, and the third AI model may comprise a corresponding AI model architecture and/or a corresponding AI model that performs different machine learning functions at different stages of a multi-stage AI pipeline based on respective input data. For example, a single AI model may function as both the second AI model and the third AI model, generating both remediation instruction data structures and modified IT asset data. In some embodiments, the AI model(s) 112 may comprise an assembly of sub-models that service multiple stages of the pipeline. The multi-stage AI pipeline may be characterized by discrete processing stages with distinct inputs and outputs, regardless of whether the stages are serviced by the same or different underlying AI models.

In some embodiments, one or more of the processing stages of the multi-stage AI pipeline may utilize multiple AI models. For example, a first stage of the multi-stage AI pipeline may utilize two or more of the AI models 112 that collectively generate a structured differential data set, with each model performing a different analysis pass on multigraph differential data. Similarly, a second stage or a third stage of the multi-stage AI pipeline may utilize multiple AI models that collectively generate remediation instruction data structures or modified IT asset data, respectively.

The computing devices of the system 100 may each communicate in whole or in part over a portion of one or more communication network(s). For example, each of the components of the system 100 can be communicatively coupled to transmit data to and/or receive data from one another over the same and/or different wireless or wired networks. Non-limiting examples of network configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary.

In some embodiments, the automated code maintenance apparatus 102 supports automatically receiving data transmissions (e.g., API notifications), for example embodied by API request(s), procedure call(s), and/or other digital data transfers, that embody dependency change notifications. Additionally or alternatively, in some embodiments, the automated code maintenance apparatus 102 supports providing data via API request(s), procedure call(s), and/or other digital data transfers, that embody a response including confirmation of remediation action execution, modified IT asset data, and/or dashboard visualization data.

In some embodiments, the system 100 operates by receiving API notifications from dependency monitoring systems through the automated code maintenance apparatus 102. The automated code maintenance apparatus 102 determines multigraph differential data indicative of a difference between a first state and a second state of the knowledge graph 106. The multigraph differential data is input to a first AI model of the AI model(s) 112 to generate a structured differential data set. The structured differential data set is input to a second AI model of the AI model(s) 112 to generate remediation instruction data structures. The remediation instruction data structures are input to a third AI model of the AI model(s) 112 to generate modified IT asset data. The automated code maintenance apparatus 102 causes execution of a remediation action based on the modified IT asset data, such as submission of pull requests or merge requests. The knowledge graph 106 is updated based on the modified IT asset data, enabling continuous event-driven maintenance.

### EXAMPLE APPARATUS

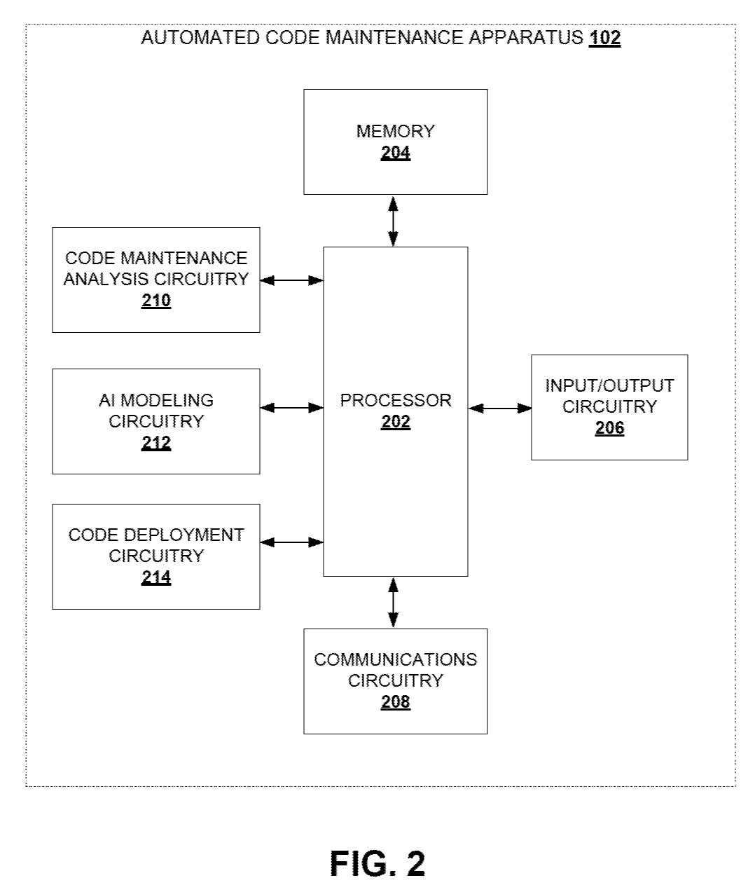

FIG. 2 illustrates a block diagram of an example apparatus that can be specially configured in accordance with at least one example embodiment of the present disclosure. Specifically, FIG. 2 illustrates the automated code maintenance apparatus 102 in accordance with at least one example embodiment of the present disclosure. The automated code maintenance apparatus 102 includes processor 202, memory 204, input/output circuitry 206, communications circuitry 208, code maintenance analysis circuitry 210, AI modeling circuitry 212, and code deployment circuitry 214. In some embodiments, the automated code maintenance apparatus 102 is configured, using one or more of the sets of circuitry 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the automated code maintenance apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the automated code maintenance apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the automated code maintenance apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the automated code maintenance apparatus 102 to carry out various functions in accordance with example embodiments of the present disclosure.

The processor 202 can be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the automated code maintenance apparatus 102, and/or one or more remote or “cloud” processor(s) external to the automated code maintenance apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the automated code maintenance apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the automated code maintenance apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the automated code maintenance apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, dependency monitoring system, MCP server 110, AI model(s) 112, and/or other external computing device in communication with the automated code maintenance apparatus 102.

In some embodiments, the automated code maintenance apparatus 102 includes the code maintenance analysis circuitry 210. The code maintenance analysis circuitry 210 includes hardware, software, firmware, and/or a combination thereof, that supports various functionality associated with determining and analyzing multigraph differential data. For example, in some embodiments, the code maintenance analysis circuitry 210 includes hardware, software, firmware, and/or a combination thereof, that determines multigraph differential data indicative of a difference between a first state and a second state of a knowledge graph for a plurality of IT assets. In some embodiments, the code maintenance analysis circuitry 210 includes hardware, software, firmware, and/or a combination thereof, that evaluates knowledge graph states stored within the knowledge graph 106 to identify differences between materialized views associated with logical graph partitions of the knowledge graph. Additionally or alternatively, in some embodiments, the code maintenance analysis circuitry 210 includes hardware, software, firmware, and/or a combination thereof, that performs impact analysis on the knowledge graph to determine impact information associated with the multigraph differential data, including cyclomatic complexity scoring, confidence scores, and security exposure analysis. In some embodiments, the code maintenance analysis circuitry 210 includes hardware, software, firmware, and/or a combination thereof, that identifies one or more unresolved IT asset references associated with graph nodes of the knowledge graph, wherein the unresolved IT asset references represent elements that connect to graph edges and are known to exist but cannot be fully described and populated without further information. Additionally or alternatively, in some embodiments, the code maintenance analysis circuitry 210 includes hardware, software, firmware, and/or a combination thereof, that enables access to one or more API(s), FTP connection(s), and/or the like to securely acquire, receive, retrieve, and/or otherwise identify data from one or more system(s) external from the automated code maintenance apparatus 102. In some embodiments, the code maintenance analysis circuitry 210 includes a separate processor, specially configured field programmable gate array (FPGA), or a specially programmed application specific integrated circuit (ASIC).

In some embodiments, the automated code maintenance apparatus 102 includes the AI modeling circuitry 212. The AI modeling circuitry 212 includes hardware, software, firmware, and/or a combination thereof, that supports various functionality associated with interfacing with the AI model(s) 112 to process differential data sets, generate remediation instruction data structures, and/or generate modified IT asset data. For example, in some embodiments, the AI modeling circuitry 212 includes hardware, software, firmware, and/or a combination thereof, that inputs the multigraph differential data to a first AI model to generate a structured differential data set for the multigraph differential data that is formatted according to input formatting criteria for a second AI model. In some embodiments, the AI modeling circuitry 212 includes hardware, software, firmware, and/or a combination thereof, that inputs the structured differential data set to the second AI model to generate a plurality of remediation instruction data structures for the plurality of IT assets. In some embodiments, the AI modeling circuitry 212 includes hardware, software, firmware, and/or a combination thereof, that inputs the plurality of remediation instruction data structures to a third AI model to generate modified IT asset data for the plurality of IT assets. Additionally or alternatively, in some embodiments, the AI modeling circuitry 212 includes hardware, software, firmware, and/or a combination thereof, that interfaces with the MCP server 110 to provide model context data via one or more MCP prompts to the AI model(s) 112. In some embodiments, the AI modeling circuitry 212 includes hardware, software, firmware, and/or a combination thereof, that supports extensible workflows of embedded or chained prompts, where results from one prompt serve as input to subsequent prompts. Additionally or alternatively, in some embodiments, the AI modeling circuitry 212 includes hardware, software, firmware, and/or a combination thereof, that enables access to one or more API(s), FTP connection(s), and/or the like to securely acquire, receive, retrieve, and/or otherwise identify data from one or more system(s) external from the automated code maintenance apparatus 102. In some embodiments, the AI modeling circuitry 212 includes a separate processor, specially configured FPGA, or a specially programmed ASIC.

In some embodiments, the automated code maintenance apparatus 102 includes the code deployment circuitry 214. The code deployment circuitry 214 includes hardware, software, firmware, and/or a combination thereof, that supports various functionality associated with executing remediation actions and deploying modified code based on outputs from the AI modeling circuitry 212. For example, in some embodiments, the code deployment circuitry 214 includes hardware, software, firmware, and/or a combination thereof, that causes execution of a remediation action for the plurality of IT assets based on the modified IT asset data. In some embodiments, the code deployment circuitry 214 includes hardware, software, firmware, and/or a combination thereof, that submits pull requests or merge requests to repositories for IT assets based on the modified IT asset data. In some embodiments, the code deployment circuitry 214 includes hardware, software, firmware, and/or a combination thereof, that updates the knowledge graph 106 based on the modified IT asset data, enabling continuous event-driven maintenance. Additionally or alternatively, in some embodiments, the code deployment circuitry 214 includes hardware, software, firmware, and/or a combination thereof, that determines updated multigraph differential data indicative of a difference between a third state (e.g., an updated current state) and the second state (e.g., the current state) of the knowledge graph following execution of a remediation action. In some embodiments, the code deployment circuitry 214 includes a separate processor, specially configured FPGA, or a specially programmed ASIC.

In some embodiments, the input/output circuitry 206 includes hardware, software, firmware, and/or a combination thereof, that generates an output associated with the automated code maintenance based at least in part on (i) the multigraph differential data determined by the code maintenance analysis circuitry 210, (ii) the remediation instruction data structures generated via the AI modeling circuitry 212, and (iii) the remediation actions executed via the code deployment circuitry 214. For example, in some embodiments, the input/output circuitry 206 includes hardware, software, firmware, and/or a combination thereof, that causes a rendering of a dashboard visualization associated with impact analysis, dependency evaluations, recommendations, and code generation via an electronic interface based at least in part on the knowledge graph 106.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 206-214 are combined into a single module embodied in hardware, software, firmware, and/or a combination thereof. Similarly, in some embodiments, one or more of the sets of circuitry, for example the code maintenance analysis circuitry 210, AI modeling circuitry 212, and/or code deployment circuitry 214, is/are combined with the processor 202, such that the processor 202 performs one or more of the operations described above with respect to each of these sets of circuitry 210-214. Additionally, one or more of the sets of circuitry, for example the code maintenance analysis circuitry 210, AI modeling circuitry 212, and/or code deployment circuitry 214, and/or the processor 202 may be communicatively coupled to and/or integrated with the automated code maintenance system 104.

In some embodiments, one or more external systems (such as a remote cloud computing and/or data storage system) may also be leveraged to provide at least some of the functionality discussed herein. For example, in some embodiments, the AI model(s) 112 are hosted on external cloud computing systems and are accessed by the automated code maintenance apparatus 102 via the communications circuitry 208. Additionally or alternatively, in some embodiments, the knowledge graph 106 is hosted on external data storage systems and is accessed by the automated code maintenance apparatus 102 via the communications circuitry 208.

### EXAMPLE DATA FLOWS FOR PROVIDING AUTOMATED CODE MAINTENANCE USING ARTIFICIAL INTELLIGENCE

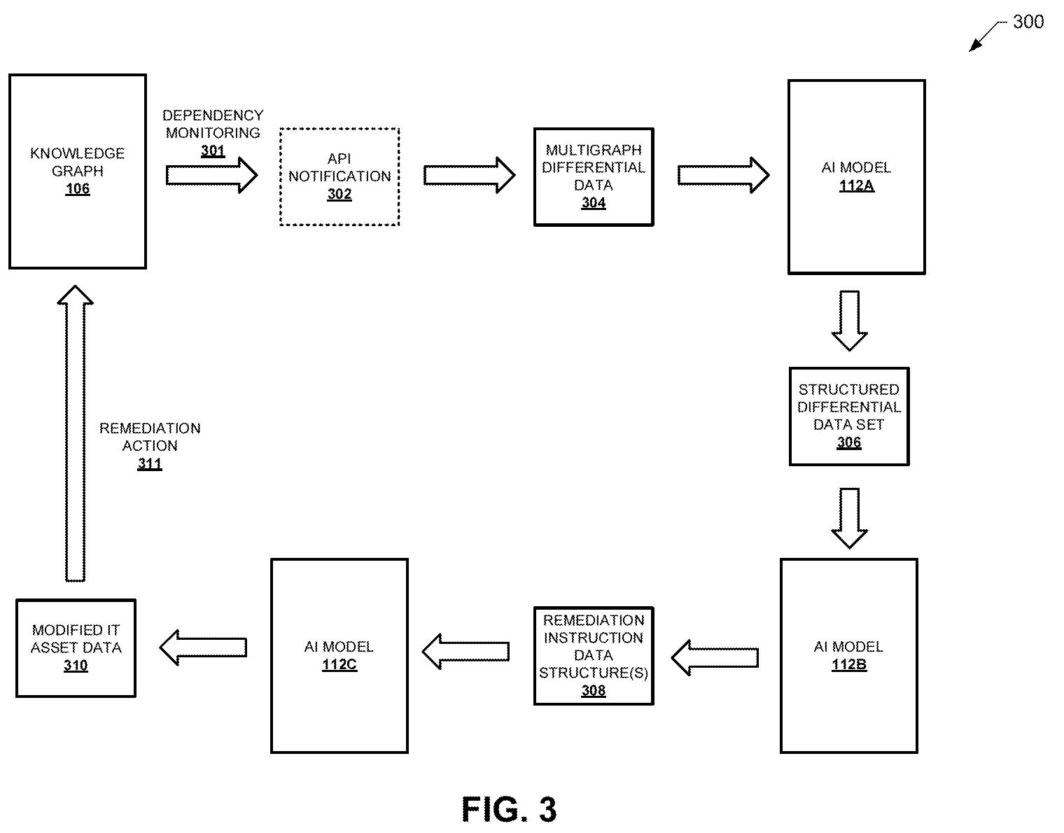

FIG. 3 illustrates a flowchart for a data flow system 300 for automated code maintenance using artificial intelligence in accordance with one or more embodiments of the present disclosure. The data flow system 300 depicts the data flow and component interactions within the automated code maintenance system 104, illustrating how dependency changes are detected, analyzed, processed through multiple AI models, and remediated through the coordination of the various components described herein. Additionally, the data flow system 300 depicts functionality between the various sub-systems of the system 100, including the automated code maintenance apparatus 102.

As illustrated in the data flow system 300, dependency monitoring 301 monitors a knowledge graph 106. The knowledge graph 106 stores data and instructions utilized by the automated code maintenance apparatus 102 during operation. In some embodiments, the knowledge graph 106 maintains dependency information associated with a plurality of IT assets. For example, the knowledge graph 106 may store configuration data, metadata, and structural information about code-generated artifacts, source code, data architecture, data schema, and/or other elements related to application system dependencies. In some embodiments, the knowledge graph 106 includes scanspace logical graph partitions which are used to store inbound data from agents. The agents use a combination of methods and mechanisms to gather structural information about sets of code-generated artifacts, source code, data architecture, data schema, and/or other elements related to application system dependencies and architecture.

The dependency monitoring 301 represents a continuous monitoring process that evaluates the knowledge graph 106 for changes in the knowledge graph. In some embodiments, the dependency monitoring 301 monitors the knowledge graph based on an IT asset vulnerability rules set that defines conditions under which notifications should be generated. The dependency monitoring 301 may operate as part of an automated maintenance loop that functions without user input, enabling continuous event-driven maintenance of IT assets. For instance, the knowledge graph 106 may be updated continuously as changes are detected. In some embodiments, the dependency monitoring 301 operates periodically at a predetermined interval (e.g., hourly, daily, or weekly intervals). In other embodiments, the dependency monitoring 301 operates on an event-driven basis, where monitoring is triggered by user input, external triggers from external systems, security-related triggers (e.g., vulnerability triggers), and/or other triggering events. In some embodiments, the dependency monitoring 301 utilizes mechanisms that interact via APIs to accept notifications from dependency monitoring systems. Additionally, the dependency monitoring 301 may evaluate annotations or attributes added to IT assets that inform the system of important conditions to evaluate for change notifications.

The dependency monitoring 301 generates an API notification 302 when changes are detected in the knowledge graph. The API notification 302 may indicate a difference between a first state and a second state of the knowledge graph 106. In some embodiments, the API notification 302 is generated by a dependency monitoring system that monitors the knowledge graph based on an IT asset vulnerability rules set. The API notification 302 serves as a trigger for the automated remediation workflow, initiating the process of analyzing differential data and generating remediation actions. In some embodiments, the API notification 302 may be received from automated agents or other dependency monitoring tools that detect changes in libraries, frameworks, or other dependencies utilized by the IT assets.

In response to the API notification 302, the data flow system 300 determines multigraph differential data 304 indicative of a difference between a first state and a second state of the knowledge graph for a plurality of IT assets. The multigraph differential data 304 represents the differences identified between states of the knowledge graph, capturing changes in dependencies, relationships, and/or structural information for the IT assets. In some embodiments, the multigraph differential data 304 comprises one or more unresolved IT asset references associated with a graph node of the knowledge graph. The unresolved IT asset references, also referred to as search nodes, represent elements that connect to a graph edge and are known to exist but cannot be fully described and populated without further information, potentially from some other system.

In some embodiments, the first state and the second state of the knowledge graph 106 are represented as a respective materialized view associated with a logical graph partition of the knowledge graph 106. The materialized views are logical partitions that can generate complete or subset views of data composited from scanspace partitions. Additionally, the materialized views may be used to create differential comparisons between different sets of scanspace data, with reference to search nodes. The multigraph differential data 304 may comprise hundreds to thousands of lines of differential data representing changes across the IT assets monitored by the system 100. In some embodiments, the multigraph differential data 304 represents a comparison between a current state of the IT assets and a prior state of the IT assets, enabling detection of changes that have occurred over time. In some embodiments, the multigraph differential data 304 represents a comparison between a current state of the IT assets and a proposed state of the IT assets, enabling analysis of proposed edits or modifications before deployment. For example, a user may propose a modification to an IT asset, and the system may generate multigraph differential data 304 by comparing the current deployed state with the proposed state to identify dependencies that would be affected by the proposed modification. In other embodiments, the multigraph differential data 304 represents a comparison between two proposed states of the IT assets, enabling evaluation of alternative modification approaches.

The multigraph differential data 304 is then input to an AI model 112A, which processes the differential data to generate a structured differential data set 306. The AI model 112A performs complex analysis of graph differentials to generate the structured differential data set 306. In some embodiments, the AI model 112A performs analysis of graph differential data to transform the multigraph differential data 304 into a format suitable for subsequent processing. The structured differential data set 306 is formatted according to input formatting criteria suitable for a second AI model (e.g., AI model 112B). In some embodiments, the AI model 112A is communicatively coupled to the MCP server 110 that provides model context data via one or more MCP prompts. In some such embodiments, the automated code maintenance apparatus 102 inputs (i) the multigraph differential data 304 and (ii) the one or more MCP prompts to the AI model 112A to generate the structured differential data set 306.

The structured differential data set 306 represents the output of the first stage of AI processing in the multi-stage AI pipeline. The structured differential data set 306 organizes and formats the differential information from the multigraph differential data 304 in a manner that enables effective processing by subsequent AI models. In some embodiments, the structured differential data set 306 includes categorized changes, prioritized impacts, and structured representations of the differences identified in the knowledge graph. The formatting of the structured differential data set 306 according to input formatting criteria for the AI model 112B enables efficient and accurate generation of remediation instructions in the subsequent processing stage.

The structured differential data set 306 is then input to an AI model 112B, which generates remediation instruction data structures 308 based on the structured differential data. The AI model 112B processes the structured differential data set 306 to generate a plurality of remediation instruction data structures 308 for the plurality of IT assets. The remediation instruction data structures 308 contain instructions for addressing the differences identified in the knowledge graph 106. In some embodiments, the remediation instruction data structures 308 comprise tickets that contain instructions for addressing the differences identified in the knowledge graph. In some embodiments, the remediation instruction data structures 308 may include actionable tickets with associated prompts that effectively serve as prompt generation for subsequent AI processing (e.g., by AI model 112C).

In some embodiments, addressing the differences identified in the knowledge graph 106 includes resolving dependency conflicts that would result from proposed changes. For example, a proposed modification to an IT asset may cause a dependency in the knowledge graph 106 to break or become vulnerable, where it is desirable for the remediation instruction data structures 308 to specify an alternative approach or additional modifications to maintain functionality. In some embodiments, addressing the differences includes updating API calls to conform to new interface specifications when a library or framework is upgraded. In some embodiments, addressing the differences includes modifying data structures to accommodate schema changes in dependent databases. In some embodiments, addressing the differences includes adding compatibility layers or adapters to bridge incompatible versions of dependent IT assets. In some embodiments, addressing the differences includes identifying and resolving circular dependencies that would result from proposed changes. In some embodiments, addressing the differences includes propagating changes through cascading dependencies, where a modification to one IT asset results in generation of corresponding modifications to multiple dependent IT assets to maintain system integrity.

In some embodiments, the automated code maintenance apparatus 102 performs impact analysis on the knowledge graph to determine impact information associated with the multigraph differential data 304 prior to generating the plurality of remediation instruction data structures 308. The impact analysis may include cyclomatic complexity scoring, confidence scores, and security exposure analysis. This impact analysis enables the AI model 112B to generate remediation instruction data structures 308 that account for the cascading effects of changes across the IT assets. In some embodiments, the AI model 112B is communicatively coupled to the MCP server 110 that provides model context data via one or more MCP prompts. In some such embodiments, the automated code maintenance apparatus 102 inputs (i) the structured differential data set 306 and (ii) the one or more MCP prompts to the AI model 112B to generate the plurality of remediation instruction data structures 308.

The remediation instruction data structures 308 are subsequently input to an AI model 112C, which generates modified IT asset data 310 based on the remediation instructions. The AI model 112C directs a coding AI to write code based on the remediation instruction data structures 308, with continuous checking and rechecking of the generated code. The modified IT asset data 310 represents updated code or configuration changes for the IT assets. For instance, the remediation instruction data structures 308 may comprise structured prompts that specify the context, rules, and/or constraints for code generation. In some embodiments, a remediation instruction data structure may include a description of the affected IT asset, the specific dependency change that triggered the remediation, the expected behavior after remediation, and/or any constraints on the modification such as maintaining backward compatibility or adhering to coding standards. The remediation instruction data structures 308 may additionally or alternatively include code snippets or templates that guide the AI model 112C in generating the modified IT asset data 310. In some embodiments, the remediation instruction data structures 308 may additionally or alternatively include test cases or validation criteria that the AI model 112C uses to verify the correctness of the generated code. Further, the remediation instruction data structures 308 may additionally or alternatively include references to documentation, API specifications, and/or other resources that provide context for the code generation task. In some embodiments, the AI model 112C performs continuous checks via MCP prompt workflows until complete, including impact assessments and dependency evaluations, generation of recommendations, and code generation.

In some embodiments, the AI model 112C is communicatively coupled to the MCP server 110 that provides model context data via one or more MCP prompts. In some such embodiments, the automated code maintenance apparatus 102 inputs (i) the plurality of remediation instruction data structures 308 and (ii) the one or more MCP prompts to the AI model 112C to generate the modified IT asset data 310. The MCP server 110 may interact with analysis and plug-in engine APIs to access knowledge graph data, differential analysis results, and impact information. The MCP server 110 provides data structure and context via MCP prompts and supports extensible workflows of embedded or chained prompts, where results from one prompt serve as input to subsequent prompts.

The modified IT asset data 310 represents the output of the third stage of AI processing in the multi-stage AI pipeline. The modified IT asset data 310 comprises updated code, configuration changes, and/or other modifications to the IT assets that address the differences identified in the knowledge graph. In some embodiments, the modified IT asset data 310 includes generated code that has been checked and rechecked by the AI model 112C to ensure accuracy and compatibility with the existing IT asset architecture. The modified IT asset data 310 may include modifications to multiple IT assets across the plurality of IT assets monitored by the system 100.

The data flow system 300 then causes execution of a remediation action 311 based on the modified IT asset data 310. In some embodiments, the remediation action 311 comprises submission of pull requests or merge requests to repositories for IT assets. The remediation action 311 represents the deployment of the modifications generated by the AI model 112C to the IT assets. In some embodiments, the code deployment circuitry 214 of the automated code maintenance apparatus 102 causes execution of the remediation action 311 for the plurality of IT assets based on the modified IT asset data 310.

In some embodiment, the remediation action 311 updates the knowledge graph 106, completing an iterative workflow. This iterative nature of the data flow system 300 enables continuous event-driven maintenance, where changes detected in the knowledge graph trigger the automated remediation workflow, and the resulting modifications are fed back into the knowledge graph for subsequent monitoring and analysis. In some embodiments, the automated code maintenance apparatus 102 updates the knowledge graph based on the modified IT asset data 310, determines updated multigraph differential data indicative of a difference between a third state (e.g., an updated current state) and the second state (e.g., the current state) of the knowledge graph, and inputs the updated multigraph differential data to the AI model 112A to generate a second structured differential data set for the updated multigraph differential data that is formatted according to the input formatting criteria for the AI model 112B.

In some embodiments, following execution of the remediation action 311, the automated code maintenance apparatus 102 may perform post-remediation analysis to identify additional IT asset data improvement opportunities. For example, after updating an IT asset to utilize a latest version of a library or framework, the data flow system 300 may analyze the updated IT asset to identify improvements that take advantage of new features, optimizations, and/or capabilities available in the updated library or framework. The post-remediation analysis may generate IT asset data improvement suggestions, refactoring recommendations, or additional modification opportunities that were identified during the remediation process. In some embodiments, the AI model(s) 112 may generate post-remediation improvement data comprising suggested IT asset data modifications that enhance the IT assets beyond one or more previous changes performed for a particular remediation. The post-remediation improvement data may include suggestions accumulated during the remediation process, such as deprecated IT asset data replacements, performance optimizations, and/or enhanced functionality utilization.

In some embodiments, the modified IT asset data 310 is fed back into the automated code maintenance workflow for self-verification prior to execution of the remediation action 311. For example, after the AI model 112C generates the modified IT asset data 310, the data flow system 300 may update a temporary version of the knowledge graph 106 based on the modified IT asset data 310 and determine verification multigraph differential data indicative of any remaining differences or issues. The verification multigraph differential data is then processed through the AI model(s) 112 to identify any secondary issues that were introduced by the initial modifications or that were not addressed by the initial remediation.

In a self-verification example, the AI model 112C may generate modified IT asset data 310 that updates a library dependency from version 1.0 to version 2.0. Upon providing the modified IT asset data 310 back into the workflow, the data flow system 300 may detect that the library update introduced a breaking change to an API method signature that affects a second IT asset not identified in the initial analysis. The data flow system 300 may then generates additional remediation instruction data structures to address the secondary issue, and the AI model 112C generates additional modified IT asset data to update the second IT asset. This iterative self-verification process may continue until the data flow system 300 determines that no remaining issues are present, at which point the consolidated modified IT asset data may be used to execute the remediation action 311.

In some embodiments, the multigraph differential data 304 is generated by a differential analysis engine that does not utilize artificial intelligence. For example, the differential analysis engine may comprise a rule-based comparison system that evaluates the first state and the second state of the knowledge graph 106 to identify differences based on predefined comparison rules. In some embodiments, the differential analysis engine utilizes graph comparison algorithms to identify added, removed, and/or modified nodes and edges between states of the knowledge graph 106. In some embodiments, the differential analysis engine is implemented as part of an analysis and plug-in engine and generates the multigraph differential data 304 using deterministic comparison operations rather than AI-based analysis. The multigraph differential data 304 generated by the non-AI differential analysis engine may then input to the AI model 112A for further processing and generation of the structured differential data set 306.

In some embodiments, the automated code maintenance apparatus 102 inputs the second structured differential data set to the AI model 112B to generate a second plurality of remediation instruction data structures for the plurality of IT assets, inputs the second plurality of remediation instruction data structures to the AI model 112C to generate second modified IT asset data for the plurality of IT assets, and causes execution of a second remediation action for the plurality of IT assets based on the second modified IT asset data. This iterative process enables the system 100 to reevaluate based on change request functionality and loop the process in the event of problems detected in generated code.

The data flow system 300 combines the dependency monitoring 301, the API notification 302, the multigraph differential data 304, the AI models 112A, 112B, and 112C, the structured differential data set 306, the remediation instruction data structures 308, the modified IT asset data 310, and the remediation action 311 to provide automated code maintenance with comprehensive dependency analysis and AI-directed remediation. The data flow system 300 operates as a continuous event-driven maintenance loop where updates to IT assets trigger knowledge graph updates, which generate notifications that lead to differential analysis, followed by AI-directed generation of IT asset data that produces new updated IT asset data, perpetuating the cycle. This automated maintenance loop may operate without user input, enabling directed AI operations for automated code maintenance.

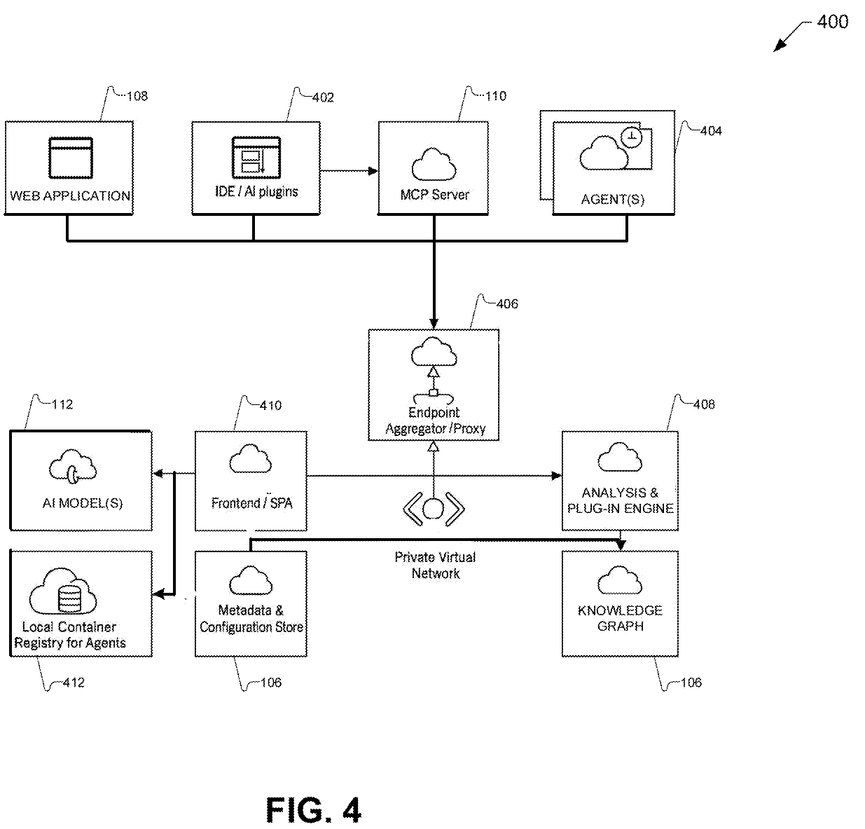

FIG. 4 illustrates a block diagram of a directed AI system 400 for automated code maintenance in accordance with one or more embodiments of the present disclosure. The directed AI system 400 depicts the system architecture and component interactions within the system 100, illustrating how code analysis requests are received, processed through multiple components, and utilized to generate differential data sets, remediation instructions, and modified IT asset data through the coordination of the various components described herein. Additionally, the directed AI system 400 depicts functionality between the various sub-systems of the system 100, including the automated code maintenance apparatus 102.

As illustrated in the directed AI system 400, a web application 108 provides a user interface for interacting with the directed AI system 400. In some embodiments, the web application 108 comprises a browser-based SPA with API access that enables users to access functionality of the automated code maintenance system 104. In some embodiments, the web application 108 facilitates user interaction with the system 100 through network communications, enabling users to initiate code maintenance operations, view impact analysis results, and monitor remediation actions. The web application 108 may be utilized to render electronic interfaces that provide details associated with impact analysis, dependency evaluations, recommendations, and/or code generation.

The directed AI system 400 also includes IDE/AI plugins 402 that are communicatively coupled to an MCP server 110. The IDE/AI plugins 402 enable integration with integrated development environments (IDEs) and AI-assisted development tools, enabling access to the functionality of the directed AI system 400 directly within client device workflows. In some embodiments, the IDE/AI plugins 402 provide interactive scenarios where developers can query the knowledge graph, perform impact analysis, and/or receive recommendations for code modifications. The IDE/AI plugins 402 may also communicate with the MCP server 110 to access model context data and facilitate communication between the development environment and the AI model(s) 112.

The MCP server 110 provides model context data to the AI model(s) 112 via one or more MCP prompts. In some embodiments, the MCP server 110 interacts with analysis and plug-in engine APIs to access knowledge graph data, differential analysis results, and impact information. The MCP server 110 provides data structure and context via MCP prompts and supports extensible workflows of embedded or chained prompts, where results from one prompt serve as input to subsequent prompts. In some embodiments, the MCP server 110 facilitates communication between the IDE/AI plugins 402 and the agent(s) 404, enabling coordinated operations across the directed AI system 400.

The directed AI system 400 also includes agent(s) 404 that are configured to gather structural information about code-generated artifacts, source code, data architecture, and other elements related to application system dependencies. The agent(s) 404 may be configured to collect dependency information from various sources. In some embodiments, the agent(s) 404 support multiple programming languages and platforms including Java, .NET, database systems, JavaScript, Python, native code, and/or Neo4j graph databases. The agent(s) 404 perform binary artifact decomposition, runtime inspection, and database schema scanning to comprehensively map IT asset dependencies. In some embodiments, the agent(s) 404 communicate with the MCP server 110 to coordinate data collection operations and transmit gathered structural information to the analysis and plug-in engine 408.

An endpoint aggregator/proxy 406 receives communications from the web application 108, the MCP server 110, and the agent(s) 404, and routes these communications to appropriate components within a private virtual network. In this regard, the endpoint aggregator/proxy 406 may serve as an intermediary between external connections and internal services of the directed AI system 400. In some embodiments, the endpoint aggregator/proxy 406 provides security and access control functionality, ensuring that communications between external components and internal components are properly authenticated and authorized. The endpoint aggregator/proxy 406 may also perform load balancing and traffic management to optimize the performance of the directed AI system 400.

Within the private virtual network, a frontend/SPA 410 is communicatively coupled to the endpoint aggregator/proxy 406 and provides a single-page application interface. The frontend/SPA 410 is connected to the AI model(s) 112. The AI model(s) may perform various AI operations including impact analysis, code generation, and/or recommendation generation. In some embodiments, the frontend/SPA 410 renders user interfaces that display impact analysis results, dependency evaluations, and generated recommendations. The frontend/SPA 410 may also provide interfaces for viewing and managing remediation instruction data structures and modified IT asset data generated by the AI model(s) 112.

The analysis and plug-in engine 408 is communicatively coupled to the endpoint aggregator/proxy 406 and performs analysis operations on data received from the agent(s) 404. The analysis and plug-in engine 408 is also connected to the knowledge graph 106. In some embodiments, the analysis and plug-in engine 408 computes graph placeholder references referred to as unresolved references or search nodes. These are defined graph types that specifically represent elements that connect to a graph edge and are known to exist but cannot be fully described and populated without further information, potentially from some other system. The analysis and plug-in engine 408 may also manage scanspace logical graph partitions which are used to store inbound data from the agent(s) 404.

In some embodiments, the analysis and plug-in engine 408 generates multiple logical graph partitions referred to as materialized views. These logical partitions can generate complete or subset views of data composited from scanspace partitions. Additionally, the analysis and plug-in engine 408 utilizes the materialized views to create differential comparisons between different sets of scanspace data, with reference to search nodes. The analysis and plug-in engine 408 may implement specific functional feature implementations that consume aspects of the above functionality, referred to as Release Assistant, Change Requests, and Advanced Reporting. Additionally, the analysis and plug-in engine 408 may provide rapid graph analysis functionality referred to as Impact Analysis.

The knowledge graph 106 maintains configuration data and metadata for the directed AI system 400 and is connected to the frontend/SPA 410. In some embodiments, the knowledge graph 106 manages dependency relationships between the plurality of IT assets. The knowledge graph 106 may store configuration data, metadata, and structural information about code-generated artifacts, source code, data architecture, data schema, and other elements related to application system dependencies. The knowledge graph 106 includes scanspace logical graph partitions which are used to store inbound data from the agent(s) 404.

The AI model(s) 112 perform various AI operations for code maintenance tasks within the directed AI system 400. In some embodiments, the AI model(s) 112 include a first AI model, a second AI model, and a third AI model that process data in stages, with each model receiving output from the preceding model to progressively transform differential graph data into actionable code modifications for IT asset remediation. The AI model(s) 112 may perform impact assessments, dependency evaluations, generation of recommendations, and IT asset generation with comprehensive understanding of IT asset architecture and dependencies. In some embodiments, the AI model(s) 112 are not reliant on a specific model and may support different models, integrated development environments, and/or other configurations.

A local container registry for agents 412 is connected to the AI model(s) 112 and stores container images for the agent(s) 404, enabling deployment and management of agent instances within the directed AI system 400. In some embodiments, the local container registry for agents 412 provides zero-footprint installation capabilities, allowing agents to be deployed without permanent installation on target systems. The local container registry for agents 412 may also facilitate updates and version management for the agent(s) 404, ensuring that the latest agent capabilities are available for code analysis and dependency scanning operations.

In some embodiments, the directed AI system 400 operates by receiving code analysis requests through the web application 108 or the IDE/AI plugins 402. The requests are routed through the endpoint aggregator/proxy 406 to the appropriate internal components. The agent(s) 404 gather structural information about code-generated artifacts, source code, data architecture, and/or other elements related to application system dependencies. The analysis and plug-in engine 408 processes the gathered information and updates the knowledge graph stored in the knowledge graph 106. The AI model(s) 112 process multigraph differential data to generate structured differential data sets, remediation instruction data structures, and modified IT asset data. The frontend/SPA 410 renders user interfaces displaying the results of the analysis and remediation operations.

The directed AI system 400 combines the web application 108, the IDE/AI plugins 402, the MCP server 110, the agent(s) 404, the endpoint aggregator/proxy 406, the analysis and plug-in engine 408, the frontend/SPA 410, the local container registry for agents 412, the AI model(s) 112, and the knowledge graph 106 to provide automated code maintenance with comprehensive dependency analysis and AI-directed remediation. The directed AI system 400 enables both interactive scenarios through the IDE/AI plugins 402 and automated maintenance operations through the continuous event-driven maintenance loop. In some embodiments, the directed AI system 400 may be a server system.

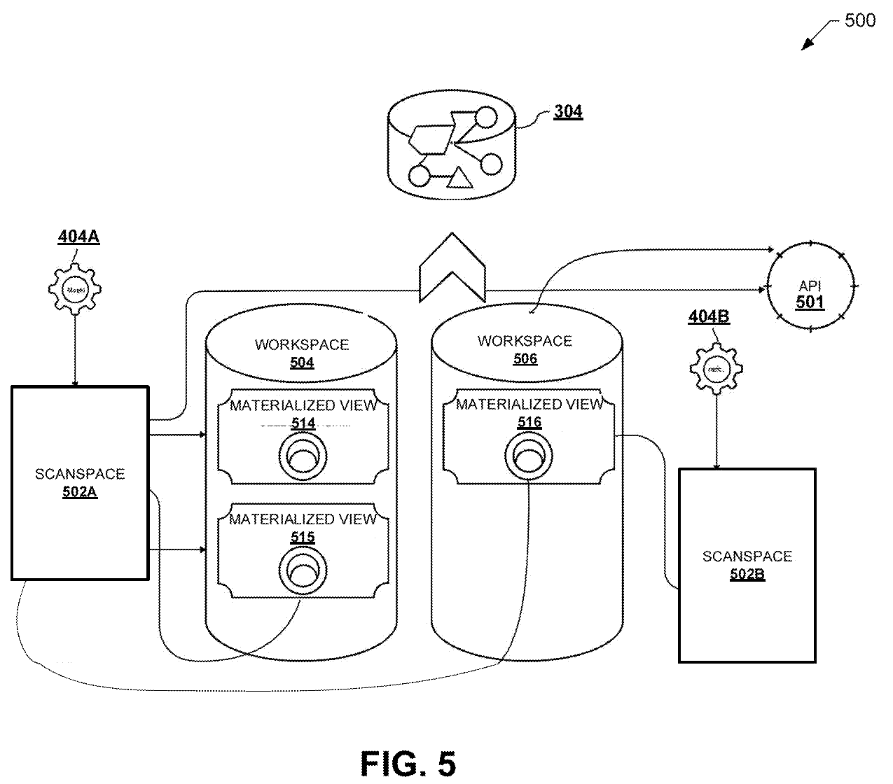

FIG. 5 illustrates a block diagram of a system 500 for managing knowledge graph data across multiple logical partitions in accordance with one or more embodiments of the present disclosure. The system 500 depicts the data architecture and component interactions for organizing, storing, and analyzing IT asset dependency information through scanspace partitions, workspaces, and materialized views. Additionally, the system 500 depicts functionality between the various sub-systems of the system 100, including the automated code maintenance apparatus 102 and the analysis and plug-in engine 408.

As illustrated in the system 500, multigraph differential data 304 is positioned at the top of the system 500 and represents differential information indicative of differences between states of the knowledge graph 106. The multigraph differential data 304 is connected to both a first workspace 504 and a second workspace 506, enabling differential comparisons to be performed across multiple logical partitions of the knowledge graph 106. In some embodiments, the multigraph differential data 304 comprises one or more unresolved IT asset references associated with graph nodes of the knowledge graph 106. The unresolved IT asset references, also referred to as search nodes, represent elements that connect to graph edges and are known to exist but cannot be fully described and populated without further information, potentially from some other system.

The system 500 includes a first agent 404A that is communicatively coupled to a first scanspace 502A. The first agent 404A uses a combination of methods and mechanisms to gather structural information about sets of code-generated artifacts, source code, data architecture, data schema, and other elements related to application system dependencies and architecture. In some embodiments, the first agent 404A performs binary artifact decomposition, runtime inspection, and database schema scanning to comprehensively map IT asset dependencies. The first agent 404A may support multiple programming languages and platforms including Java, .NET, database systems, JavaScript, Python, native code, and Neo4j graph databases.

The first scanspace 502A serves as a logical graph partition configured to store inbound data from the first agent 404A. In some embodiments, the first scanspace 502A comprises a scanspace logical graph partition that receives and organizes structural information gathered by the first agent 404A. The first scanspace 502A may store dependency data, relationship information, and metadata associated with the IT assets analyzed by the first agent 404A. The first scanspace 502A is connected to the first workspace 504, enabling the data stored within the first scanspace 502A to be accessed and processed by components within the first workspace 504.

The system 500 further includes a second agent 404B that is communicatively coupled to a second scanspace 502B. The second agent 404B operates similarly to the first agent 404A, gathering structural information about code-generated artifacts, source code, data architecture, and other elements related to application system dependencies. In some embodiments, the second agent 404B may analyze a different set of IT assets, a different version of IT assets, or IT assets from a different source than those analyzed by the first agent 404A. The second agent 404B may transmit gathered structural information to the second scanspace 502B for storage and subsequent processing.

The second scanspace 502B serves as another logical graph partition configured to store inbound data from the second agent 404B. In some embodiments, the second scanspace 502B comprises a scanspace logical graph partition that receives and organizes structural information gathered by the second agent 404B. The second scanspace 502B is connected to the second workspace 506, enabling the data stored within the second scanspace 502B to be accessed and processed by components within the second workspace 506.

An API 501 is positioned to receive data from the multigraph differential data 304 and is also connected to the second agent 404B and the second scanspace 502B. In some embodiments, the API 501 provides an application programming interface that enables external systems to interact with the system 500, including submitting dependency change notifications, querying knowledge graph data, and retrieving differential analysis results. The API 501 may receive API notifications from dependency monitoring systems that monitor the knowledge graph based on an IT asset vulnerability rules set. Additionally, the API 501 may facilitate communication between the system 500 and dependency monitoring systems, enabling the automated maintenance loop to accept notifications and trigger remediation workflows.

The first workspace 504 contains a first materialized view 514 and a second materialized view 515. The first materialized view 514 and the second materialized view 515 represent logical partitions that generate complete or subset views of data composited from scanspace partitions. In some embodiments, the first materialized view 514 generates a complete view of data from the first scanspace 502A, while the second materialized view 515 generates a subset view or an alternative composition of data from the first scanspace 502A. The materialized views within the first workspace 504 may be utilized to create differential comparisons between different sets of scanspace data, with reference to search nodes.

In some embodiments, the first materialized view 514 represents a current state of the knowledge graph for a set of IT assets, while the second materialized view 515 represents a prior state of the knowledge graph for the same set of IT assets. This configuration enables the system 500 to determine multigraph differential data indicative of a difference between the first state and the second state of the knowledge graph 106. The materialized views may include audit zipstream components and additional processing elements that facilitate tracking of changes and generation of differential data.

The second workspace 506 contains a third materialized view 516. The third materialized view 516 represents a logical partition that generates complete or subset views of data composited from the second scanspace 502B. In some embodiments, the third materialized view 516 may represent a different version of IT assets, a different set of IT assets, or IT assets from a different source than those represented by the materialized views within the first workspace 504. The third materialized view 516 enables the system 500 to maintain and analyze multiple distinct sets of IT asset dependency information.

The first workspace 504 and the second workspace 506 are interconnected, allowing for differential comparisons between different sets of scanspace data. In some embodiments, the interconnection between the first workspace 504 and the second workspace 506 enables the system 500 to compare IT asset dependencies across different workspaces, identifying differences that may require remediation. This cross-workspace comparison capability supports scenarios where IT assets from different sources, different versions, or different organizational units need to be analyzed together to identify dependency conflicts or compatibility issues.

In some embodiments, the system 500 operates by receiving structural information from the first agent 404A and the second agent 404B. The first agent 404A transmits gathered structural information to the first scanspace 502A, while the second agent 404B transmits gathered structural information to the second scanspace 502B. The first scanspace 502A and the second scanspace 502B store the inbound data in their respective logical graph partitions. The first workspace 504 generates the first materialized view 514 and the second materialized view 515 based on data from the first scanspace 502A. The second workspace 506 generates the third materialized view 516 based on data from the second scanspace 502B.

In some embodiments, the system 500 determines the multigraph differential data 304 by comparing materialized views within a workspace or across workspaces. For example, the system 500 may compare the first materialized view 514 with the second materialized view 515 to identify differences between a first state and a second state of the knowledge graph for IT assets analyzed by the first agent 404A. Alternatively, the system 500 may compare the first materialized view 514 with the third materialized view 516 to identify differences between IT assets analyzed by the first agent 404A and IT assets analyzed by the second agent 404B.

The multigraph differential data 304 generated by the system 500 may comprise hundreds to thousands of lines of differential data representing changes across the IT assets monitored by the system 100. In some embodiments, the multigraph differential data 304 includes graph differentials that are key to computing impact, including particular edges that represent dependencies that have been disrupted by changes to IT assets. The multigraph differential data 304 is subsequently input to AI models to generate structured differential data sets, remediation instruction data structures, and modified IT asset data as part of the automated code maintenance workflow.

In some embodiments, the system 500 supports role-based access control (RBAC) security levels within each workspace. The first workspace 504 and the second workspace 506 may each contain RBAC security level configurations that control access to the scanspace partitions and materialized views within the respective workspace. The RBAC security levels enable the system 500 to enforce access controls that restrict which users or systems can view, modify, or analyze particular sets of IT asset dependency information.

The system 500 combines the multigraph differential data 304, the first agent 404A, the second agent 404B, the API 501, the first scanspace 502A, the second scanspace 502B, the first workspace 504, the second workspace 506, the first materialized view 514, the second materialized view 515, and the third materialized view 516 to provide comprehensive knowledge graph data management with support for multiple logical partitions and differential analysis. The system 500 enables the collection and organization of structural information about code-generated artifacts, source code, data architecture, and other elements related to application system dependencies, supporting the automated code maintenance operations performed by the system 100.

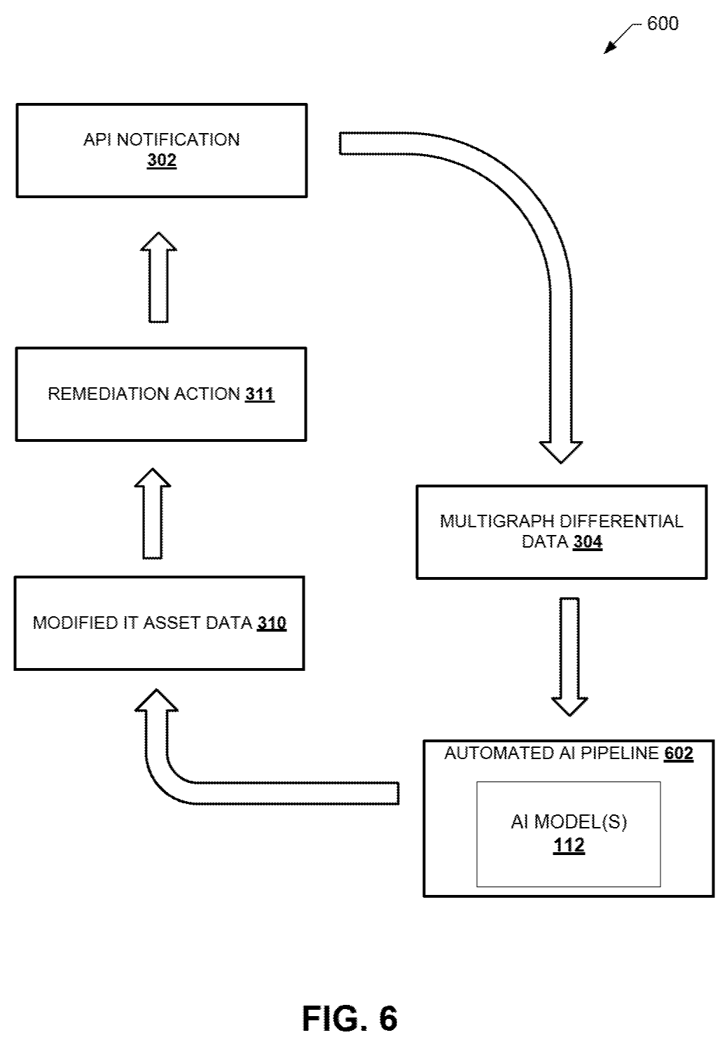

FIG. 6 illustrates a process 600 that includes an automated AI pipeline for code maintenance in accordance with one or more embodiments of the present disclosure. The process 600 depicts the data flow and component interactions within the automated code maintenance system 104, illustrating how dependency change notifications trigger automated remediation workflows through the coordination of AI models and the continuous event-driven maintenance loop. Additionally, the process 600 depicts functionality between the various sub-systems of the system 100, including the automated code maintenance apparatus 102.

As illustrated in the process 600, an API notification 302 serves as the initial trigger for the automated remediation workflow. The API notification 302 indicates a difference between a first state and a second state of the knowledge graph stored in the knowledge graph 106. In some embodiments, the API notification 302 is generated by a dependency monitoring system that monitors the knowledge graph based on an IT asset vulnerability rules set. The API notification 302 may be received from automated agents other dependency monitoring tools that detect changes in libraries, frameworks, or other dependencies utilized by the IT assets. Additionally, the API notification 302 may be generated based on annotations or attributes added to IT assets that inform the system of important conditions to evaluate for change notifications.

In response to the API notification 302, the process 600 determines multigraph differential data 304 indicative of a difference between a first state and a second state of the knowledge graph for a plurality of IT assets. The multigraph differential data 304 represents the differences identified between states of the knowledge graph, capturing changes in dependencies, relationships, and/or structural information for the IT assets. In some embodiments, the multigraph differential data 304 represents a comparison between a current deployed state and a proposed state of the IT assets, enabling analysis of proposed modifications before deployment. In other embodiments, the multigraph differential data 304 represents a comparison between a current deployed state and a prior deployed state of the IT assets. In some embodiments, the multigraph differential data 304 comprises one or more unresolved IT asset references associated with a graph node of the knowledge graph. The unresolved IT asset references, also referred to as search nodes, represent elements that connect to a graph edge and are known to exist but cannot be fully described and populated without further information, potentially from some other system. In some examples, the multigraph differential data 304 may comprise hundreds to thousands of lines of differential data representing changes across the IT assets monitored by the system 100.

In some embodiments, the first state and the second state of the knowledge graph are represented as a respective materialized view associated with a logical graph partition of the knowledge graph. The materialized views are logical partitions that can generate complete or subset views of data composited from scanspace partitions. Additionally, the materialized views may be used to create differential comparisons between different sets of scanspace data, with reference to search nodes. The multigraph differential data 304 includes graph differentials that are key to computing impact, including particular edges that represent dependencies that have been disrupted by changes to IT assets.

The multigraph differential data 304 is then input to an automated AI pipeline 602, which contains AI model(s) 112. The automated AI pipeline 602 represents the multi-stage AI processing architecture that transforms differential graph data into actionable code modifications for IT asset remediation. In some embodiments, the automated AI pipeline 602 includes a first AI model, a second AI model, and a third AI model that process data in stages, with each model receiving output from the preceding model. The AI model(s) 112 within the automated AI pipeline 602 perform various AI operations including impact assessments, dependency evaluations, generation of recommendations, and IT asset generation with comprehensive understanding of IT asset architecture and dependencies.

In some embodiments, the automated AI pipeline 602 processes the multigraph differential data 304 through the AI model(s) 112 in a sequential manner. A first AI model of the AI model(s) 112 receives the multigraph differential data 304 and generates a structured differential data set that is formatted according to input formatting criteria for a second AI model. The first AI model performs complex analysis of graph differentials to generate the structured differential data set, including mass analysis of graph differential data to transform the multigraph differential data 304 into a format suitable for subsequent processing.

The structured differential data set is then input to a second AI model of the AI model(s) 112, which generates a plurality of remediation instruction data structures for the plurality of IT assets. In some embodiments, the remediation instruction data structures comprise work tickets that contain instructions for addressing the differences identified in the knowledge graph. The remediation instruction data structures may include actionable tickets with associated prompts that effectively serve as prompt generation for subsequent AI processing.

The plurality of remediation instruction data structures is subsequently input to a third AI model of the AI model(s) 112, which generates modified IT asset data 310 for the plurality of IT assets. In some embodiments, the third AI model directs a coding AI to write code based on the remediation instruction data structures, with continuous checking and rechecking of the generated code. The third AI model may perform continuous checks via MCP prompt workflows until complete, including impact assessments and dependency evaluations, generation of recommendations, and code generation.

In some embodiments, at least one of the first AI model, the second AI model, or the third AI model within the AI model(s) 112 is communicatively coupled to the MCP server 110 that provides model context data via one or more MCP prompts. The MCP server 110 may interact with analysis and plug-in engine APIs to access knowledge graph data, differential analysis results, and impact information. The MCP server 110 provides data structure and context via MCP prompts and supports extensible workflows of embedded or chained prompts, where results from one prompt serve as input to subsequent prompts. In some embodiments, the AI model(s) 112 are not reliant on a specific model and may support different models, integrated development environments, and other configurations.

The automated AI pipeline 602 generates modified IT asset data 310 based on the processing performed by the AI model(s) 112. The modified IT asset data 310 represents updated code or configuration changes for the IT assets that address the differences identified in the knowledge graph. In some embodiments, the modified IT asset data 310 includes generated code that has been checked and rechecked by the AI model(s) 112 to ensure accuracy and compatibility with the existing IT asset architecture. The modified IT asset data 310 may include modifications to multiple IT assets across the plurality of IT assets monitored by the system 100.

The modified IT asset data 310 is then used to execute a remediation action 311. In some embodiments, the remediation action 311 comprises submission of pull requests or merge requests to repositories for IT assets. The remediation action 311 represents the deployment of the modifications generated by the AI model(s) 112 to the IT assets. In some embodiments, the code deployment circuitry 214 of the automated code maintenance apparatus 102 causes execution of the remediation action 311 for the plurality of IT assets based on the modified IT asset data 310.

Following the remediation action 311, the process 600 flows back to the API notification 302, creating an iterative workflow. This iterative nature of the process 600 establishes a continuous event-driven maintenance loop where the system can repeatedly receive notifications, analyze differential data, generate modifications through the AI model(s) 112, and execute remediation actions. In some embodiments, the remediation action 311 updates the knowledge graph 106, which may trigger subsequent API notifications 302 as the dependency monitoring system detects changes resulting from the remediation.

In some embodiments, the automated code maintenance apparatus 102 updates the knowledge graph based on the modified IT asset data 310, determines updated multigraph differential data indicative of a difference between a third state (e.g., an updated current state) and the second state (e.g., the current state) of the knowledge graph, and inputs the updated multigraph differential data to the first AI model to generate a second structured differential data set for the updated multigraph differential data that is formatted according to the input formatting criteria for the second AI model. In some such embodiments, the automated code maintenance apparatus 102 inputs the second structured differential data set to the second AI model to generate a second plurality of remediation instruction data structures for the plurality of IT assets, inputs the second plurality of remediation instruction data structures to the third AI model to generate second modified IT asset data for the plurality of IT assets, and causes execution of a second remediation action for the plurality of IT assets based on the second modified IT asset data. This iterative process enables the system 100 to reevaluate based on change request functionality and loop the process in the event of problems detected in generated code.

The process 600 demonstrates an automated approach to code maintenance where the automated AI pipeline 602 operates in a feedback loop, allowing for ongoing monitoring and remediation of IT assets without requiring manual intervention at each iteration. In some embodiments, the process 600 operates as part of an automated maintenance loop that functions without user input, enabling lights-out directed AI operations for ongoing code maintenance. The process 600 may be driven by dependency change notifications from automated agents, annotation-driven notifications from the IT assets, or other extensible notification mechanisms.

The process 600 combines the API notification 302, the multigraph differential data 304, the automated AI pipeline 602 containing the AI model(s) 112, the modified IT asset data 310, and the remediation action 311 to provide automated code maintenance with comprehensive dependency analysis and AI-directed remediation. The iterative workflow of the process 600 enables continuous event-driven maintenance where updates to IT assets trigger knowledge graph updates, which generate notifications that lead to differential analysis, followed by AI-directed generation of IT asset data that produces new updated IT asset data, perpetuating the cycle. This automated maintenance loop reduces or eliminates the time and resources traditionally required for library and framework upgrades by automating impact analysis, ticket generation, and modification of IT asset data.

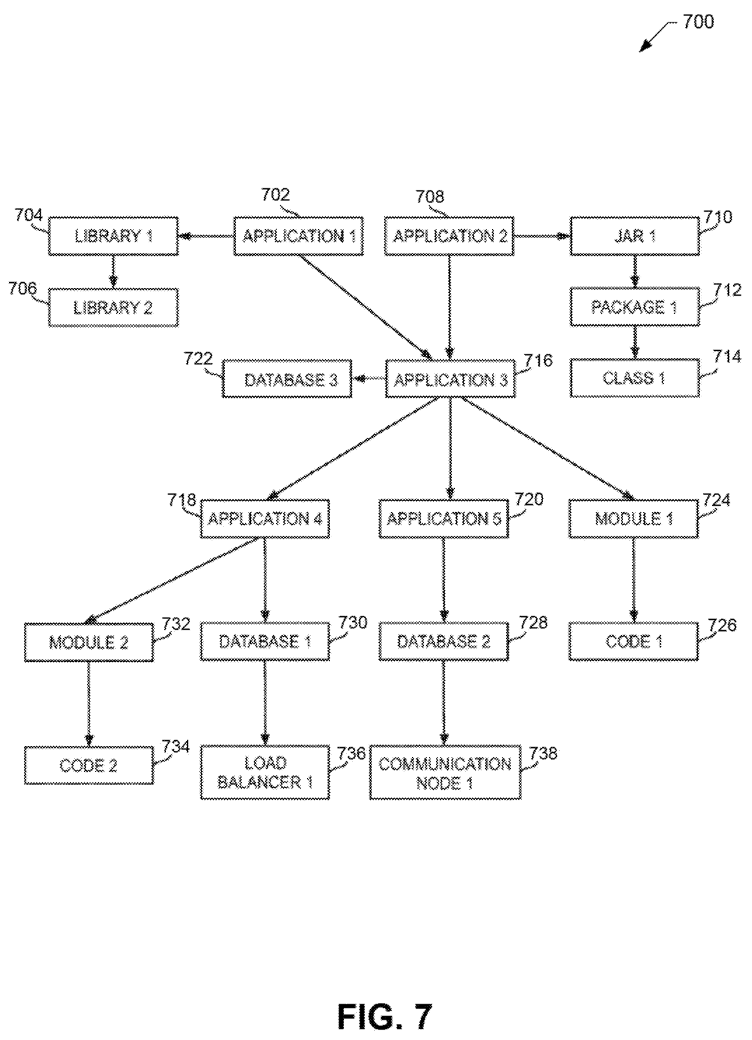

FIG. 7 illustrates an example representation 700 showing inter-dependency of a plurality of IT assets utilized in a computing system such as an enterprise computing system, in accordance with an example embodiment of the present invention. To understand an integrated description of all dimensions/domains of enterprise architecture, such as business, applications and technology, an illustrative example of the enterprise architecture of a television (TV) cable company may be considered. An existing customer of the TV cable company may wish to subscribe for some extra TV channels and request the same through the subscription services provided by the cable company. Such a request triggers the process “request subscription” that will initiate a process performed by an employee of the company. The employee first validates the request by using a “customer administration application” of the company to check the administrative situation of the customer, as recorded in a “customer information database”. If no problem arises, the employee may accept the request for subscription, otherwise the request may get rejected. The proposed architectural description distinguishes different layers of the enterprise e.g., the TV cable company of the example scenario. The business layer offers services to customers that are realized in the organization by business processes (performed by employees), and the application layer supports the business layer with application services that are realized by IT asset applications. The technology layer offers infrastructure services (e.g., processing, storage and communication services) needed to run applications, realized by computers and communication devices. Components of application layer and the technology layer may herein collectively be referred to as the plurality of IT assets of the enterprise computing system in accordance with an example embodiment of the invention.

As shown in the simplified schematic representation, Application 1 (see 702 ) depends on Library 1 (see 704 ). The Library 1 depends on Library 2 (see 706 ). Application 2 (see 708 ) depends on Jar 1 (see 710 ) which is again dependent on Package 1 (see 712 ). The Package 1 further depends on Class 1 (see 714 ). The Application 1 and the Application 2 collectively depend on an Application 3 (see 716 ). Further, the Application 3 depends on Application 4 (see 718 ), Application 5 (see 720 ), Database 3 (see 722 ) and Module 1 (see 724 ). Further, the Module 1 depends on a Code 1 (see 726 ). The Application 5 depends on Database 2 (see 728 ) and the Application 4 depends on Database 1 (see 730 ) and a Module 2 (see 732 ). The Module 2 is again dependent on Code 2 (see 734 ). The Database 1 is dependent on Load balancer 1 (see 736 ) and the Database 2 (see 728 ) is dependent on Communication node 1 (see 738 ). Hence, multiple dependencies are possible between various IT assets in an enterprise computing system. The user(s) may view the dependency map of various IT assets either at a high level, a code level or any abstraction level between the high level and the code level.

### EXAMPLE METHOD(S)

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence can be altered without departing from the scope of the present disclosure. For example, some of the operations depicted can be performed in parallel or in a different sequence that does not materially affect the function of the processes.

The blocks indicate operations of each process. Such operations can be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart can be combinable, replaceable, and/or otherwise altered as described herein.

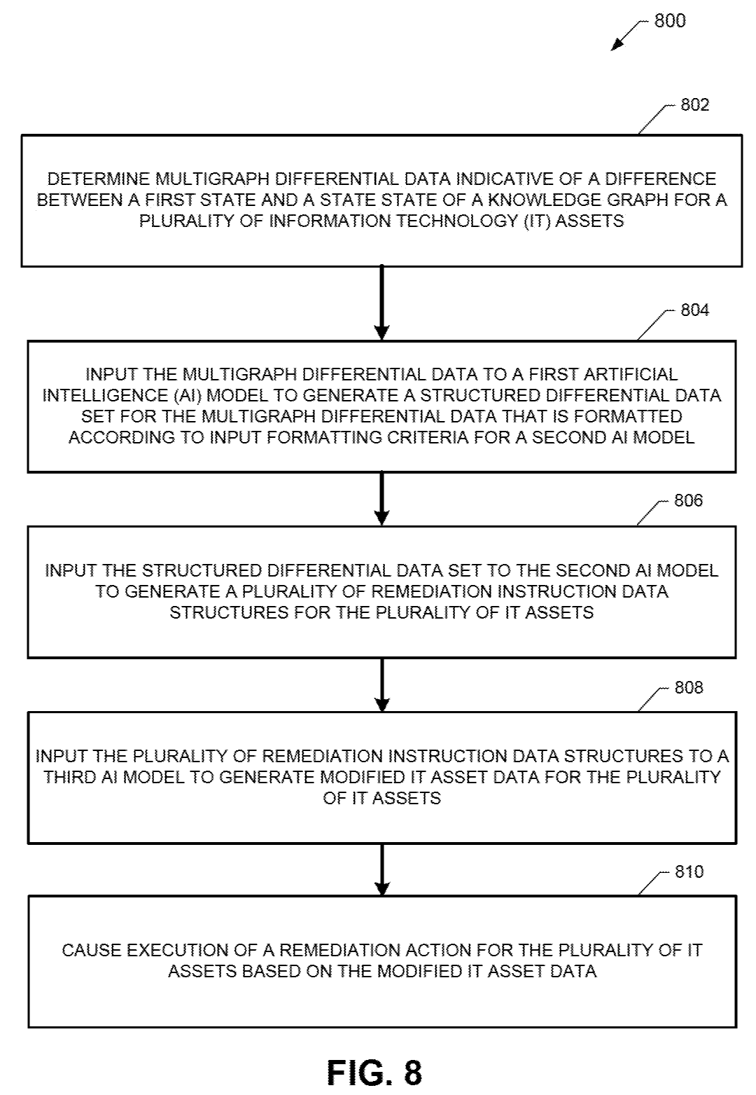

FIG. 8 illustrates a process 800 depicting example operations for providing automated code maintenance using artificial intelligence in accordance with at least one embodiment of the present disclosure. The process 800 embodies an example computer-implemented method. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the automated code maintenance apparatus 102 alone or in communication with one or more other component(s), device(s), system(s), and/or the like. In this regard, in some such embodiments, the automated code maintenance apparatus 102 is specially configured by computer-coded instructions (e.g., computer program instructions) stored thereon, for example in the memory 204 and/or another component depicted and/or described herein and/or otherwise accessible to the automated code maintenance apparatus 102, for performing the operations as depicted and described. In some embodiments, the automated code maintenance apparatus 102 is in communication with one or more external apparatus(es), system(s), device(s), and/or the like, to perform one or more of the operations as depicted and described. For example, the automated code maintenance apparatus 102 in some embodiments is in communication with a separate primary system, client system, and/or the like. For purposes of simplifying the description, the process 800 is described as performed by and from the perspective of the automated code maintenance apparatus 102.

According to some examples, the process 800 includes determining multigraph differential data indicative of a difference between a first state and a second state of a knowledge graph for a plurality of Information Technology (IT) assets, at block 802.

According to some examples, the process 800 includes inputting the multigraph differential data to a first artificial intelligence (AI) model to generate a structured differential data set for the multigraph differential data that is formatted according to input formatting criteria for a second AI model, at block 804.

According to some examples, the process 800 includes inputting the structured differential data set to the second AI model to generate a plurality of remediation instruction data structures for the plurality of IT assets, at block 806.

According to some examples, the process 800 includes inputting the plurality of remediation instruction data structures to a third AI model to generate modified IT asset data for the plurality of IT assets, at block 808.

According to some examples, the process 800 includes causing execution of a remediation action for the plurality of IT assets based on the modified IT asset data, at block 810.

Although the process 800 depicts a particular sequence of operations, the sequence may be altered without departing from the scope of the present disclosure. For example, some of the operations depicted may be performed in parallel or in a different sequence that does not materially affect the function of the processes. Additionally, such operations may be performed in any of a number of ways, including, without limitation, in the order and manner as depicted and described herein. In some examples, the process 800 includes some or all operations described and/or depicted. Similarly, it should be appreciated that one or more of the operations of the process 800 may be combinable, replaceable, and/or otherwise altered as described herein.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus comprising one or more processors and one or more storage devices storing instructions that are operable, when executed by the one or more processors, to cause the one or more processors to:
determine multigraph differential data indicative of a difference between a first state and a second state of a knowledge graph for a plurality of Information Technology (IT) assets;
input the multigraph differential data to a first artificial intelligence (AI) model to generate a structured differential data set for the multigraph differential data that is formatted according to input formatting criteria for a second AI model;
input the structured differential data set to the second AI model to generate a plurality of remediation instruction data structures for the plurality of IT assets;
input the plurality of remediation instruction data structures to a third AI model to generate modified IT asset data for the plurality of IT assets; and
cause execution of a remediation action for the plurality of IT assets based on the modified IT asset data.

2. The apparatus of claim 1, wherein the one or more storage devices store instructions that are operable, when executed by the one or more processors, to further cause the one or more processors to:
determine the multigraph differential data in response to an application programming interface (API) notification that indicates the difference between the first state and the second state of the knowledge graph.

3. The apparatus of claim 2, wherein the API notification is generated by a dependency monitoring system that monitors the knowledge graph based on an IT asset vulnerability rules set.

4. The apparatus of claim 1, wherein the structured differential data set is a first structured differential data set, and wherein the one or more storage devices store instructions that are operable, when executed by the one or more processors, to further cause the one or more processors to:
update the knowledge graph based on the modified IT asset data;
determine updated multigraph differential data indicative of a difference between a third state and the second state of the knowledge graph; and
input the updated multigraph differential data to the first AI model to generate a second structured differential data set for the updated multigraph differential data that is formatted according to the input formatting criteria for the second AI model.

5. The apparatus of claim 4, wherein the plurality of remediation instruction data structures is a first plurality of remediation instruction data structures, the modified IT asset data is first modified IT asset data, the remediation action is a first remediation action, and the one or more storage devices store instructions that are operable, when executed by the one or more processors, to further cause the one or more processors to:
input the second structured differential data set to the second AI model to generate a second plurality of remediation instruction data structures for the plurality of IT assets;
input the second plurality of remediation instruction data structures to a third AI model to generate second modified IT asset data for the plurality of IT assets; and
cause execution of a second remediation action for the plurality of IT assets based on the second modified IT asset data.

6. The apparatus of claim 1, wherein the one or more storage devices store instructions that are operable, when executed by the one or more processors, to further cause the one or more processors to:
perform impact analysis on the knowledge graph to determine impact information associated with the multigraph differential data prior to generating the plurality of remediation instruction data structures.

7. The apparatus of claim 1, wherein the multigraph differential data comprises one or more unresolved IT asset references associated with a graph node of the knowledge graph.

8. The apparatus of claim 1, wherein the first state and the second state of the knowledge graph are represented as a respective materialized view associated with a logical graph partition of the knowledge graph.

9. The apparatus of claim 1, wherein at least one of the first AI model, the second AI model, or the third AI model is communicatively coupled to a model context protocol (MCP) server that provides model context data via one or more MCP prompts.

10. The apparatus of claim 9, wherein the one or more storage devices store instructions that are operable, when executed by the one or more processors, to further cause the one or more processors to:
input (i) the multigraph differential data and (ii) the one or more MCP prompts to the first AI model to generate the structured differential data set;
input (i) the structured differential data set and (ii) the one or more MCP prompts to the second AI model to generate the plurality of remediation instruction data structures; or
input (i) the plurality of remediation instruction data structures and (ii) the one or more MCP prompts to the third AI model to generate the modified IT asset data.

11. The apparatus of claim 1, wherein the one or more storage devices store instructions that are operable, when executed by the one or more processors, to further cause the one or more processors to:
update a particular portion of the knowledge graph based on the modified IT asset data;
determine verification multigraph differential data indicative of a difference between a state of the particular portion of the knowledge graph and a target state;
in response to the verification multigraph differential data indicating one or more vulnerabilities:
input the verification multigraph differential data to the first AI model to generate a verification structured differential data set;
input the verification structured differential data set to the second AI model to generate a plurality of verification instruction data structures;
input the plurality of verification instruction data structures to the third AI model to generate verification IT asset data; and
cause execution of the remediation action for the plurality of IT assets based on the verification IT asset data.

12. The apparatus of claim 1, wherein at least two of the first AI model, the second AI model, and the third AI model comprise a corresponding AI model architecture.

13. The apparatus of claim 1, wherein at least one of the first AI model, the second AI model, or the third AI model comprises a plurality of AI models that collectively perform a respective AI processing stage.

14. The apparatus of claim 1, wherein the one or more storage devices store instructions that are operable, when executed by the one or more processors, to further cause the one or more processors to:
responsive to execution of the remediation action, perform post-remediation analysis on the modified IT asset data to identify one or more IT asset data improvement opportunities associated with the remediation action; and
generate post-remediation improvement data comprising one or more suggested IT asset data modifications that enhance the plurality of IT assets.

15. The apparatus of claim 14, wherein the post-remediation improvement data comprises at least one of:
a recommendation to utilize a new feature available in an updated library or framework for the plurality of IT assets,
a refactoring recommendation identified during the remediation action, or
performance optimization opportunity associated with the modified IT asset data.

16. A computer-implemented method, comprising:
determining multigraph differential data indicative of a difference between a first state and a second state of a knowledge graph for a plurality of Information Technology (IT) assets;
inputting the multigraph differential data to a first artificial intelligence (AI) model to generate a structured differential data set for the multigraph differential data that is formatted according to input formatting criteria for a second AI model;
inputting the structured differential data set to the second AI model to generate a plurality of remediation instruction data structures for the plurality of IT assets;
inputting the plurality of remediation instruction data structures to a third AI model to generate modified IT asset data for the plurality of IT assets; and
causing execution of a remediation action for the plurality of IT assets based on the modified IT asset data.

17. The computer-implemented method of claim 16, further comprising:
determining the multigraph differential data in response to an application programming interface (API) notification that indicates the difference between the first state and the second state of the knowledge graph.

18. The computer-implemented method of claim 16, wherein the structured differential data set is a first structured differential data set, and the computer-implemented method further comprising:
updating the knowledge graph based on the modified IT asset data;
determining updated multigraph differential data indicative of a difference between a third state and the second state of the knowledge graph; and
inputting the updated multigraph differential data to the first AI model to generate a second structured differential data set for the updated multigraph differential data that is formatted according to the input formatting criteria for the second AI model.

19. The computer-implemented method of claim 18, wherein the plurality of remediation instruction data structures is a first plurality of remediation instruction data structures, the modified IT asset data is first modified IT asset data, the remediation action is a first remediation action, and the computer-implemented method further comprises:
inputting the second structured differential data set to the second AI model to generate a second plurality of remediation instruction data structures for the plurality of IT assets;
inputting the second plurality of remediation instruction data structures to a third AI model to generate second modified IT asset data for the plurality of IT assets; and
causing execution of a second remediation action for the plurality of IT assets based on the second modified IT asset data.

20. The computer-implemented method of claim 16, further comprising:
updating a particular portion of the knowledge graph based on the modified IT asset data;
determining verification multigraph differential data indicative of a difference between a state of the particular portion of the knowledge graph and a target state;
in response to the verification multigraph differential data indicating one or more vulnerabilities:
inputting the verification multigraph differential data to the first AI model to generate a verification structured differential data set;
inputting the verification structured differential data set to the second AI model to generate a plurality of verification instruction data structures;
inputting the plurality of verification instruction data structures to the third AI model to generate verification IT asset data; and
causing execution of the remediation action for the plurality of IT assets based on the verification IT asset data.

21. One or more non-transitory computer-readable storage media storing instructions that, when executed by one or more processors, cause the one or more processors to:
determine multigraph differential data indicative of a difference between a first state and a second state of a knowledge graph for a plurality of Information Technology (IT) assets;
input the multigraph differential data to a first artificial intelligence (AI) model to generate a structured differential data set for the multigraph differential data that is formatted according to input formatting criteria for a second AI model;
input the structured differential data set to the second AI model to generate a plurality of remediation instruction data structures for the plurality of IT assets;
input the plurality of remediation instruction data structures to a third AI model to generate modified IT asset data for the plurality of IT assets; and
cause execution of a remediation action for the plurality of IT assets based on the modified IT asset data.
